(19) United States
(12) Patent Application Publication
(10) Pub. No.: US 2024/0236003 A1
(43) Pub. Date: Jul. 11, 2024

(54) FLOW CONTROL FEEDBACK IN AN INTEGRATED ACCESS AND BACKHAUL NETWORK

(71) Applicant: CANON KABUSHIKI KAISHA, Tokyo (JP)

(72) Inventors: Pascal LAGRANGE, La Chappelle des Fougeretz (FR); Pierre VISA, RENNES (FR)

(21) Appl. No.: 18/563,833

(22) PCT Filed: May 27, 2022
(86) PCT No.: PCT/EP2022/064389

§ 371 Date: Nov. 22, 2023

(30) Foreign Application Priority Data
May 27, 2021 (GB) 2107610.4

(51) Int. Cl. H04L 47/17; H04L 47/122; H04W 28/02; H04W 88/08

(52) U.S. Cl. CPC H04L 47/17; H04L 47/122; H04W 28/0278; H04W 88/085

(57) ABSTRACT

A method for processing a flow control feedback in an IAB network comprising a plurality of IAB nodes is disclosed. Each IAB node is configured to deliver data received over an ingress link to an egress link. The method, at the IAB node, comprises receiving, from another IAB node over an egress backhaul link between the IAB node and the another IAB node, a flow control feedback comprising link identification information, determining at least one ingress backhaul link for use in forwarding the flow control feedback, updating information included in the flow control feedback for at least one of the determined at least one ingress backhaul link to provide an updated flow control feedback for the at least one of the determined at least one ingress backhaul link, transmitting the updated flow control feedback over the at least one of the determined at least one ingress backhaul link.

### FIELD OF THE INVENTION

The present invention generally relates to flow control feedback in an Integrated Access and Backhaul (IAB) network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems-based IEEE 802.11 standards, such as WiFi.

The demand for network densification (e.g. denser placement of base stations) increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications or links (between base stations) may use the same radio resources as access communications or links (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver.

To cope with these potential radio link failures, a topological redundancy can be provided within the IAB framework, where multiple backhaul paths are set up between the IAB base station directly connected to the core network (also referred to as the “IAB-donor”) and the IAB base station serving a UE (also referred to as the “access IAB-node” for the UE). Several intermediate IAB base stations (also referred to as IAB-nodes) may be involved in each of the several backhaul paths between the IAB-donor and the access IAB-node, thus forming alternative data paths within a multi-hop IAB network.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network. A back-up path is also useful in case of congestion of a link due to an excessive demand of application traffic compared to the default link capacity. Traffic re-routing to a back-up path or load balancing between the default path and one or more back-up paths may be activated to mitigate the congestion.

In the IAB-network topology, the direction from the IAB-donor toward the access IAB-nodes (and thus the UEs) is referred to as downstream, hence defining a parent IAB-node and a child IAB-node for each link. The direction toward the IAB-donor is referred to as upstream. Each IAB-node coupled directly or indirectly to the IAB-donor comprises an IAB-MT (IAB-Mobile Termination) to communicate in the upstream direction and an IAB-DU (IAB-Distributed Unit) to communicate in the downstream direction. Downstream and upstream are terms equivalent to downlink and uplink terms used for the transmissions between a legacy 5G base station (gNB) and a UE.

Like a gNB, the IAB-donor consists of a central unit (CU or gNB-CU functionality) and of one or more distributed unit(s) (DU or gNB-DU functionality). The IAB-donor-CU hosts higher layer protocols for controlling operation of one or more DUs and each of the one or more IAB-donor-DUs include lower layer protocols including the Physical layer and Radio Frequency part. The IAB-donor-CU and the one or more IAB-donor-DUs may be located far from each other. Then a wired IP network (typically with fiber connections) exists to interconnect these different devices. The interest of having several DUs connected to a single CU is the centralization and the resource sharing of less time-critical operations in the CU (virtualization), while time-critical operations like scheduling, fast retransmission, segmentation . . . are performed in the DUs.

To enable routing over multiple backhaul hops, a specific IAB protocol sublayer is introduced, the backhaul adaptation protocol (BAP) sublayer, which is specified in the 3GPP release-16 specifications TS 38.340 (version 16.3.0). There is one BAP entity in each IAB-MT, one BAP entity in each IAB-DU, and one BAP entity in each IAB-donor-DU. A unique BAP address is assigned to each IAB-node and to each IAB-donor-DU. The BAP sublayer encapsulates IP SDUs (Service Data Units) into BAP PDUs (Protocol Data Units), where each BAP PDU consists of a BAP header and a payload section, which includes the IP SDUs.

The BAP header includes a BAP Routing ID, which is the concatenation of the destination BAP address and the identifier of the backhaul path to follow (Path ID). The BAP routing ID is set by the BAP sublayer of the initiator IAB-donor-DU (in the downstream direction) or the initiator IAB-node (in the upstream direction). Then, BAP PDUs are routed according to the BAP Routing ID using a backhaul routing table configured by the IAB-donor-CU in each IAB-node and in each IAB-donor-DU. Upon reception of a BAP PDU in a BAP entity, the destination BAP address is compared to the local BAP address. If the local address matches the destination BAP address, the BAP header is removed and the payload is delivered to the upper layers.

For a BAP entity in an IAB-donor-DU, if the destination BAP address does not match the local BAP address, the BAP PDU is discarded. For a BAP entity in the IAB-MT or the IAB-DU of an IAB-node, if the destination BAP address does not match the local BAP address, the BAP PDU is delivered to the collocated BAP entity for routing and transmission to the next hop. The backhaul routing table provides the egress link corresponding to the next hop BAP address, using the BAP routing ID in the BAP PDU header as the entry of the table. In case the indicated egress link is not available, for instance due to radio link failure (RLF), an entry with the same destination BAP address is selected regardless of the Path ID. The BAP PDU is discarded if no entry in the routing table matches the BAP Routing ID or the destination BAP address of the BAP header.

The BAP sublayer is on top of the Radio Link Control (RLC) sublayer, which is responsible for the segmentation and the reassembly of packets, in order to adapt them to the size that can be transmitted over the radio interface, as indicated by the Medium Access Control (MAC) sublayer. The RLC sublayer is also responsible for requesting retransmissions of missing packets with various possible policies depending on the desired Quality of Service (QOS) level.

On each backhaul link, the BAP PDUs are carried by Backhaul (BH) RLC channels. Each BH RLC channel is configured with QoS information or priority level, and multiple BH RLC channels can be configured on each BH link to allow traffic prioritization and QoS enforcement. A BAP PDU contains data associated to a radio bearer setup to transport traffic flows, and each traffic flow has a specific QoS requirement, such as data rate, latency, packet error rate. Therefore, a radio bearer is mapped on a BH RLC channel corresponding to the desired QoS level. There can be a one-to-one (1:1) mapping with one radio bearer per RLC channel, but also a many-to-one (N:1) mapping where several radio bearers having similar QoS requirements are multiplexed over the same RLC channel. Besides, two BAP PDUs carrying two different radio bearers may have the same BAP Routing ID, but they may be transmitted over two different BH RLC channels when the radio bearers are not associated to the same QoS level.

Each BH RLC channel is identified by an identifier, called BH RLC channel ID, and generated by the IAB-donor-CU. A BH RLC channel ID has link-local scope only, meaning that it uniquely identifies a BH RLC channel within a link between two IAB-nodes. Thus, the identifier of a BH RLC channel carrying a BAP PDU on the BH link between a first IAB-node and a second IAB-node may be different from the identifier of the BH RLC channel carrying the same BAP PDU on the BH link between the second IAB-node and a third IAB-node.

To complete the routing operation of a BAP PDU after the selection of an egress link, an intermediate IAB-node selects the egress BH RLC channel to forward the BAP PDU. The selection is performed using the BH RLC channel mapping configuration table configured by the IAB-donor-CU. This table provides the egress RLC channel ID according to the ingress link and the ingress BH RLC channel ID on which the BAP PDU has been received, and according to the egress link previously selected.

Within the transmission process, scheduling in a base station consists in allocating resources for downlink and uplink transmissions. In an IAB network, the downlink and uplink transmissions on backhaul links (i.e. between an IAB-node and its child IAB-nodes), and on access links (i.e. between an IAB-node and the UEs served by the IAB-node) are scheduled by the IAB-node-DU itself. As a consequence, the downlink and uplink transmissions on a backhaul link between an IAB-node-MT and its parent IAB-node are scheduled by the parent IAB-node-DU (or IAB-donor-DU). The scheduler applies scheduling weights (i.e. different priorities) to the BH RLC channels so as to respect the different QoS levels of BH RLC channels.

As defined in release 16 for 5G NR, flow control in IAB networks can be supported in both upstream and downstream directions. The flow control mechanism may be triggered by the detection of a congestion in the transmission path. The congestion may be due to bad radio link conditions leading to high packets retransmission rate, and thus to a reduction of the BH link capacity. Also, the congestion may be due to an increase of the application data rate affecting one or several radio bearers. In the downstream direction, flow control is supported on BAP sublayer, where the IAB-node (IAB-MT) can send feedback information on the available buffer size for an ingress BH RLC channel ID or BAP routing ID to its parent IAB-node. Then, the scheduler in the parent IAB-node (i.e. the IAB-DU of the parent IAB-node) may reduce the downlink data rate for a particular BH RLC channel or BAP routing ID to alleviate a reported congestion. In the upstream direction, flow control may be directly supported at the IAB-node through the uplink scheduling by the IAB-DU of the IAB-node and a reduction of uplink data rate (by reducing the allocation of resources for uplink transmissions).

However, a long-term congestion on a backhaul link may not be alleviated using the flow control mechanism without having to rely on packet dropping. Indeed, the data rate reduction in the scheduler of a parent IAB-node may alleviate a downstream congestion in a child IAB-node but it may lead to a congestion in the parent IAB-node that will need to send in turn a flow control feedback. The flow control mechanism may be repeated up to the IAB-Donor-DU, which may also experience a congestion leading to dropping packets.

Actually, there are two additional possible options to help mitigate the congestion. As a first option, an IAB-node or an IAB-donor-DU may reroute some BAP PDUs on an alternative path when it is already configured by the Donor-CU. As a second option, the IAB-Donor-CU can be warned by an IAB-node in order to compute a new routing configuration for the whole network, and to reconfigure the IAB-nodes accordingly. The drawback of both solutions is that it may take a long time to apply the corrective action, and packet dropping may not be avoided. For example, it may take a long time to apply the hop-by-hop flow control mechanism of release-16, and to reach an IAB-node able to reroute BAP PDUs. Furthermore, the time to warn the IAB-Donor-CU and to apply a new configuration may take even a longer time.

In light of the aforementioned issues, it would therefore be desirable to provide an improved mechanism for mitigating congestion in an IAB network.

### SUMMARY

In accordance with a first aspect of the present invention, there is provided a method for processing a flow control feedback in an Integrated Access and Backhaul, IAB, network comprising a plurality of IAB nodes, each IAB node of the plurality of IAB nodes configured to deliver data received over an ingress link to an egress link for transmission, the method, at the IAB node, comprising:
receiving, from another IAB node over an egress backhaul link between the IAB node and the another IAB node, a flow control feedback comprising link identification information;
determining at least one ingress backhaul link for use in forwarding the flow control feedback;
updating information included in the flow control feedback for at least one of the determined at least one ingress backhaul link to provide an updated flow control feedback for the at least one of the determined at least one ingress backhaul link;
transmitting the updated flow control feedback over the at least one of the determined at least one ingress backhaul link.

By enabling an IAB node to forward the flow control feedback received from a child IAB node (or a parent IAB node), the time to reach an IAB node that may be able to reroute some BAP PDUs on an alternative path can be significantly reduced. Thus, the time to apply corrective action to address congestion at an IAB node can be reduced compared to the time to apply the hop-by-hop flow control mechanism of release-16 and even more so compared to the time to warn the IAB Donor CU and to apply a new configuration. Furthermore, the risk of packet dropping may be reduced.

In an example, the determining at least one ingress backhaul link comprises determining, based on the link identification information, at least one ingress backhaul link for use in forwarding the flow control feedback.

In an example, information included in the flow control feedback is updated based on the link identification information to provide an updated flow control feedback for the at least one of the determined at least one ingress backhaul link.

The link identification information may include a backhaul RLC channel identifier for identifying a backhaul RLC channel of the egress backhaul link or a routing identifier, such as a backhaul adaptation protocol (BAP) routing identifier, for identifying a routing path for routing data in the IAB network to a destination IAB node.

Updating information included in the flow control feedback may include updating or adapting link identification information included in the flow control feedback, such as the backhaul RLC channel identifier(s) in the received flow control feedback, and/or status information, such as available buffer size and/or radio quality, in the received flow control feedback. Updating the link identification information of the flow control feedback may include replacing the backhaul RLC channel identifier for identifying a backhaul RLC channel of the egress backhaul link in the flow control feedback with the backhaul RLC channel identifier for the backhaul RLC channel of the ingress backhaul link to provide the updated flow control feedback for transmission over the ingress backhaul link.

Updating the link identification information may include replacing the link identification information (for example, as discussed with reference to FIG. 12 in the detailed description) or removing the link identification information, which may be a BH RLC channel identifier or a routing identifier or BAP routing identifier (for example, as discussed with reference to FIG. 13 or FIG. 15 in the detailed description).

As the reported BH RLC channel identifier (ID) is an identifier shared between first and second IAB nodes that may be different from the identifier shared between the second and a third IAB nodes, flow control feedback with a reporting per RLC channel ID, issued by a first IAB node to a second IAB node, and propagated by the second IAB node to a third IAB node may not be understood by the third IAB node. Indeed, the reported BH RLC channel ID is an identifier shared between the first and second IAB nodes that may be different from the identifier shared between the second and third IAB nodes. By adapting the flow control feedback so as to update the BH RLC channel ID to replace the BH RLC channel ID of the egress BH RLC channel (e.g. for the BH link between the second and first IAB nodes or in other words, for the egress backhaul link between the IAB node and the another IAB node (e.g. next hop IAB node)) with the BH RLC channel ID of the associated ingress BH RLC channel (e.g. for the BH link between the second and third IAB nodes or in other words, the ingress backhaul link between the IAB node and a forwarded/targeted IAB node (i.e. previous hop IAB node) to which the flow control feedback is to be forwarded), the information or content of the flow control feedback will be understood by the third IAB node (i.e. the forwarded IAB node). Thus, issues due to the fact that the backhaul RLC channel identifier has link-local scope can be avoided.

Updating may additionally or alternatively include adding or appending to the flow control feedback, to provide the updated flow control feedback, additional information for one or more additional backhaul RLC channels or one or more additional routing identifiers of the ingress backhaul link not associated with the egress backhaul link but associated with the ingress backhaul link (i.e. the forwarded/targeted IAB node is affected or concerned by the one or more additional backhaul RLC channels or one or more additional routing identifiers). The additional information may include additional backhaul RLC channel identifier(s) and status information (such as available buffer size and/or radio quality) for the additional backhaul RLC channel(s) associated with the ingress backhaul link. Alternatively, the additional information may include additional routing identifier(s) and status information (such as available buffer size and/or radio quality) for the additional routing identifier(s) associated with the ingress backhaul link. By adding or appending relevant information for a forwarded/targeted IAB node, this provides additional information to the forwarded/targeted IAB node which may help the forwarded/targeted IAB node to have a better understanding of congestion and/or radio quality issues at the IAB node (and any previous IAB nodes if applicable).

Updating may additionally or alternatively include removing from the flow control feedback, to provide the updated flow control feedback, information for one or more additional backhaul RLC channels or one or more additional routing identifiers of the ingress backhaul link not associated with the ingress backhaul link (i.e. the forwarded/targeted IAB node is not affected or concerned by the one or more additional backhaul RLC channels or one or more additional routing identifiers). The removed information may include backhaul RLC channel identifier(s) and status information (such as available buffer size and/or radio quality) for the backhaul RLC channel(s) not associated with the ingress backhaul link. Alternatively, the removed information may include routing identifier(s) and status information (such as available buffer size and/or radio quality) for the routing identifier(s) not associated with the ingress backhaul link. When a flow control feedback is forwarded over several links to different forwarded/targeted IAB nodes, the content of the flow control feedback may be different and customised for the particular forwarded/targeted IAB nodes. By removing irrelevant information for a forwarded/targeted IAB node, this may help to reduce the size of the forwarded flow control feedback message and if applicable, may also avoid confusion in case the same backhaul RLC channel identifier is used for two different backhaul links.

Typically, the flow control feedback from the another IAB node (i.e. a first IAB node) includes information on the available buffer size concerning a status of the buffer load in the another IAB node only, and it does not take into account the buffer load status in the second IAB node.

In an example, the flow control feedback further comprises status information including available buffer size for the backhaul RLC channel identified by the backhaul RLC channel identifier in the link identification information of the flow control feedback or available buffer size associated with the routing identifier in the link identification information of the flow control feedback. The method further comprises: determining the local available buffer size of at least one buffer at the IAB node, the at least one buffer being associated with the backhaul RLC channel identified by the backhaul RLC channel identifier in the flow control feedback or being associated with the routing identifier in the link identification information of the flow control feedback; comparing the local available buffer size of the buffer at the IAB node with the available buffer size included in the status information of the flow control feedback; when the local available buffer size is less than the available buffer size included in the status information of the flow control feedback, updating information included in the flow control feedback by updating the status information to include the local available buffer size to provide the updated flow control feedback. Updating the status information may include: replacing the available buffer size included in the status information of the flow control feedback with the local available buffer size; or replacing the available buffer size included in the status information of the flow control feedback with the local available buffer size and adding an update indicator to indicate that the available buffer size has been replaced with the local available buffer size; or appending the local available buffer size to the available buffer size included in the status information of the flow control feedback. By updating the status information regarding the available buffer size in the flow control feedback based on the local available buffer size at the IAB node (second IAB node) and the available buffer size in the flow control feedback before forwarding the flow control feedback, the local available buffer size at the IAB node can be taken into account at the forwarded/targeted IAB node e.g. when re-routing data or changing data rates. For example, when the local available buffer size at the IAB node is appended to the available buffer size in the flow control feedback, the buffer load status in the different IAB nodes can be taken into account by the forwarded/targeted IAB node.

In an example, the flow control feedback further comprises status information including radio quality for the backhaul RLC channel identified by the backhaul RLC channel identifier in the link identification information of the flow control feedback or radio quality associated with the routing identifier in the link identification information of the flow control feedback. The status information concerning radio quality in the flow control feedback may be updated in a similar manner to that discussed above with respect to available buffer size including in the flow control feedback with similar results.

In an example, the method may further comprise determining the received flow control feedback is to be forwarded. Determining the received flow control feedback is to be forwarded may comprise at least one of: determining that the received flow control feedback indicates congestion; or determining that the received flow control feedback indicates congestion and in response to determining that no corrective action for the congestion can be performed by the IAB node.

In accordance with a second aspect of the present invention, there is provided a method for processing a flow control feedback in an Integrated Access and Backhaul, IAB, network as recited in claim 34.

As discussed above with respect to the first aspect, by enabling an IAB node to forward the flow control feedback received from a child IAB node (or a parent IAB node), the time to reach an IAB node that may be able to reroute some BAP PDUs on an alternative path can be significantly reduced.

In accordance with a third aspect of the present invention, there is provided an Integrated access and backhaul, IAB, node, as recited in claim 35.

Further features of the invention are characterised by the other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with another aspect of the invention, there is provided a computer readable storage medium storing at least one computer program comprising instructions that, when executed by a processing unit, causes the processing unit to perform the method according to any aspect or example described above.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating a 5G Radio Access Network including a wireless Integrated Access and Backhaul (IAB) network;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram for illustrating the routing management in an IAB network;

FIG. 5 illustrates fields of routing tables in IAB-nodes according to 3GPP TS 38.300;

FIG. 6 is a schematic diagram illustrating an example topology of an IAB network presenting network path diversity in which the present invention may be implemented according to one or more exemplary embodiments;

FIG. 7a is a schematic diagram illustrating a first format of a flow control feedback per BH RLC channel;

FIG. 7b is a schematic diagram illustrating a first format of a flow control feedback per BAP routing ID;

FIG. 8a is a schematic diagram illustrating a second format of a flow control feedback per BH RLC channel;

FIG. 8b is a schematic diagram illustrating a second format of a flow control feedback per BAP routing ID;

FIG. 9 illustrates, using a flowchart, an exemplary method for forwarding by an IAB-node a flow control feedback received from a child or a parent IAB-node according to embodiments of the invention;

FIG. 10 illustrates, using a flowchart, an exemplary method for selecting backhaul link(s) to forward a flow control feedback per BH RLC channel ID by an IAB-node according to embodiments of the invention;

FIG. 11 illustrates, using a flowchart, an exemplary method for selecting backhaul link(s) to forward a flow control feedback per BAP routing ID by an IAB-node according to embodiments of the invention;

FIG. 12 illustrates, using a flowchart, an exemplary method for remapping a BH RLC channel ID in a flow control feedback forwarded by an intermediate IAB-node according to embodiments of the invention;

FIG. 13 illustrates, using a flowchart, an exemplary method for removing a BH RLC channel ID and associated status in a flow control feedback forwarded by an intermediate IAB-node according to embodiments of the invention;

FIG. 14 illustrates, using a flowchart, an exemplary method for appending a BH RLC channel ID and associated status in a flow control feedback forwarded by an intermediate IAB-node according to embodiments of the invention;

FIG. 15 illustrates, using a flowchart, an exemplary method for removing a BAP routing ID and associated status in a flow control feedback forwarded by an intermediate IAB-node according to embodiments of the invention;

FIG. 16 illustrates, using a flowchart, an exemplary method for appending a BAP routing ID and associated status in a flow control feedback forwarded by an intermediate IAB-node according to embodiments of the invention;

FIG. 17 illustrates, using a flowchart, an exemplary method for updating the available buffer size status for a reported BH RLC channel ID or BAP routing ID in a flow control feedback forwarded by an intermediate IAB-node according to embodiments of the invention;

FIG. 18 illustrates, using a flowchart, an exemplary method for updating the radio quality for a reported BH RLC channel ID or BAP routing ID in a flow control feedback forwarded by an intermediate IAB-node according to embodiments of the invention;

FIG. 19 is a block schematic diagram of an example wireless communication device for implementing embodiments of the present invention;

FIG. 20 is a schematic diagram showing an example arrangement of IAB nodes in an IAB network and the forwarding of a flow control feedback by one of the IAB nodes according to embodiments of the invention.

### DETAILED DESCRIPTION

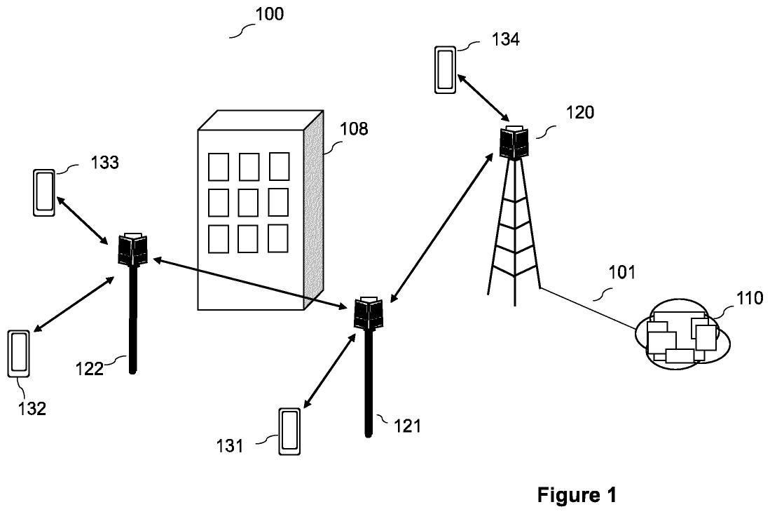

FIG. 1 illustrates a communication system 100 with a 5G Radio Access Network (RAN) including a wireless IAB network.

As depicted, the exemplary system 100 is a wireless communication system, in particular a mobile radio communication system such as a fifth-generation (5G) New Radio (NR) system. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul network which shares radio resources for wireless access links and wireless backhaul links.

The system 100 comprises a plurality of UEs (User Equipment) 132, 133, 131 and 134, a remote core network 110, a main Base Station 120, and two Integrated Access and Backhaul (IAB) stations or IAB network nodes 121 and 122.

The main Base Station 120, also referred to as the IAB-donor or donor network node 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes, IAB nodes or IAB network nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The IAB-donor 120 and the IAB-nodes 121 and 122 are thus forming a backhaul network or IAB network, which accommodates UEs 132, 133, 131 and 134.

The specification of the Integrated Access and Backhaul (IAB) is spread over several 3GPP standard documents, including:
TS 38.300 RAN architecture (V16.2.0),
TS 38.321 MAC protocol (V16.1.0),
TS 38.331 Radio Resource Control (RRC) protocol (V16.1.0),
TS 38.340 Backhaul Adaptation Protocol Layer (V16.1.0),
TS 38.401 RAN architecture (V16.2.0),
TS 38.473 F1 Application Protocol (V16.2.0).

As IAB-nodes 121 and 122 are respectively connected to UEs 131, 132 and 133, they are considered as Access IAB-nodes for their respectively connected UEs.

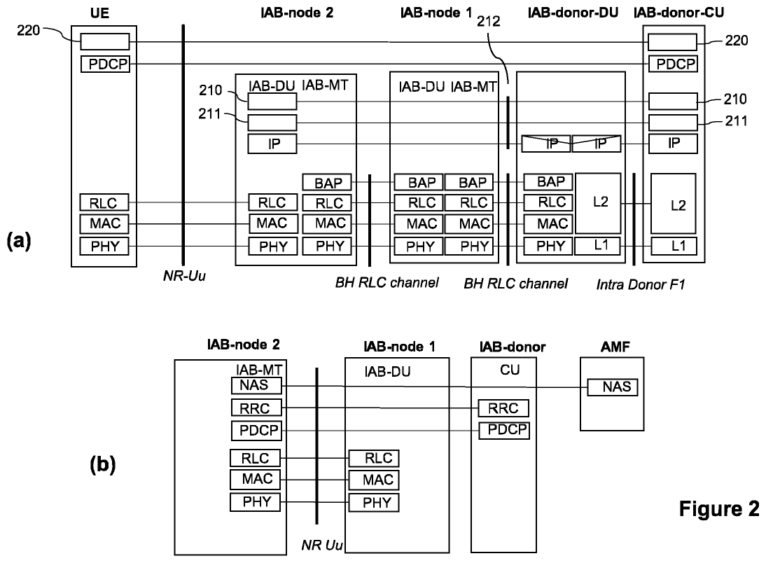

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or IAB-donor CU or donor CU hosts higher layer protocols, such as PDCP (Packet Data Convergence Protocol) and RRC (Radio Resource Control) protocols, for controlling operation of one or more DUs and each of the one or more IAB-donor-DUs or IAB-donor DU or donor DUs includes lower layer protocols, such as the RLC, MAC and physical layer protocols. The IAB-donor-CU or donor CU and IAB-donor-DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes 121, 122, which may serve multiple radio sectors, are wireless backhauled to the IAB-donor 120, via one or multiple hops. They form a directed acyclic graph (DAG) topology with the IAB-donor at its root.

Each IAB node or IAB network node consists of an IAB-DU and an IAB-MT (IAB-Mobile Termination). The gNB-DU functionality on an IAB-node is also referred to as IAB-DU and allows the downstream (toward the UE) connection to the next-hop IAB node. The IAB-MT functionality includes, e.g., physical layer, layer-2, RRC and Non Access Stratum (NAS) functionalities to connect to the gNB-DU of an upstream IAB-node (including the IAB-donor 120 in which case the IAB-MT connects to the IAB-donor-DU, hence to the IAB-donor gNB-CU and the core network 110, for instance for initialization, registration and configuration).

In this DAG topology, the neighbour node on the IAB-DU's interface is referred to as child node or child IAB-node, and the neighbour node on the IAB-MT's interface is referred to as parent node or parent IAB-node. The direction toward the child node is further referred to as downstream while the direction toward the parent node is referred to as upstream.

The IAB-donor 120 (e.g. the IAB-donor CU) performs centralized resource, topology and route management for the whole IAB network topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node DU (e.g. of IAB-node 2), and between the IAB-donor-CU and an IAB-donor-DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane (UP), boxes 210 at the IAB-donor-CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor-CU and the IAB-node DU. The well-known User Datagram Protocol (UDP) is a transport layer protocol providing a best effort datagram service and fit to be used with an IP protocol.

In the Control Plane, boxes 210 indicate the FIAP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor-CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor-CU and the IAB-node DU as defined in 3GPP TS 38.401.

The transport between the IAB-donor-DU and the IAB-donor-CU also uses an IP transport Layer over various media, like for example wires or optical fiber when the IAB-donor-CU is remote from the IAB-donor-DU, or locally in a virtual instantiation of the IAB-donor-CU and the IAB-donor-DU on the same physical machine. IAB-specific transport between IAB-donor-CU and IAB-donor-DU is specified in 3GPP TS 38.401.

L1 and L2 on FIG. 2 stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

In a downstream direction, upper layer packets are encapsulated by the BAP sublayer at the IAB-donor-DU, thus forming BAP packets or data units or data packets. The BAP packets are routed by the BAP sublayer or entity (and corresponding BAP entities in the IAB-DU and IAB-MT) of the intermediate IAB-nodes (also referred to as relay nodes), if any. The BAP packets are finally de-encapsulated by the BAP sublayer at the destination IAB-node (which may be an access IAB-node should the upper layer packets in the BAP packets be intended to a UE).

In an upstream direction, upper layer packets are encapsulated by the BAP sublayer at an initiator IAB-node (which may be an access IAB-node should the upper layer packets come from a UE), thus forming BAP packets or data units or data packets. The BAP packets are routed by the BAP sublayer (and corresponding BAP entities in the IAB-DU and IAB-MT) of the intermediate IAB-nodes, if any. The BAP packets are finally de-encapsulated by the BAP sublayer at the IAB-donor-DU.

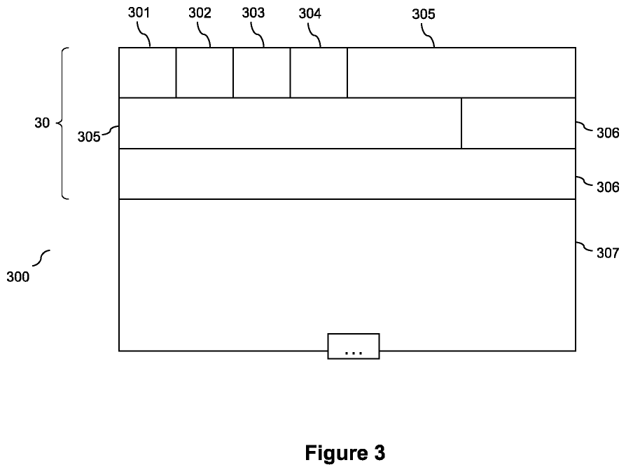

On the BAP sublayer, packets are routed based on a BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS 38.340 version 16.3.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor-DU for the BAP packet. For the purpose of routing, each IAB-node and IAB-donor-DU in an IAB network is configured (by IAB-donor-CU of the IAB network) with a designated and unique BAP address.

Field 306 carries a path ID identifying the routing BAP path the BAP packet should follow to this destination in the IAB topology. For the purpose of routing, the BAP paths, including their path ID, are configured (by IAB-donor-CU) in the IAB-nodes.

The BAP header is added to the packet when it arrives from upper layers to the BAP sublayer, and it is stripped off by the BAP sublayer when it has reached its destination node. The selection of the packet's BAP routing ID is configured by the IAB-donor-CU.

For instance, when the BAP packet is generated by a node, i.e. either by the IAB-donor-DU for downstream transmission or by an initiator IAB-node for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these tables defining the BAP paths (hence the routing strategy and the configuration of the IAB-nodes given the IAB network topology) are usually defined by the IAB-donor-CU and transmitted to the IAB-nodes to configure them.

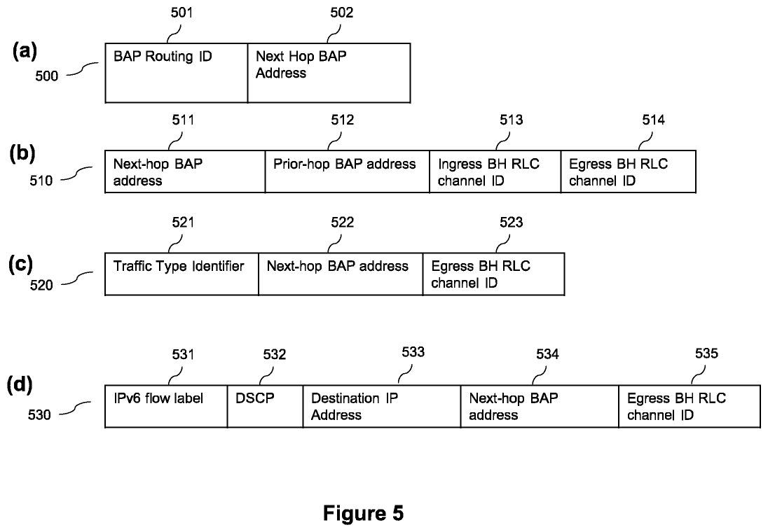

A usage of these tables (and other tables) to perform the routing is described below with reference to FIG. 5.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS 38.322. The MAC (Media Access Channel) protocol sublayer is responsible for selecting available transmission formats for the user data and for the mapping of logical channels to the transport channels. The MAC also handles a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, and TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS38.324. On the UE side, the SDAP sublayer exchanges the payload data with the user's application (voice, video, etc.—not shown in the Figure). On the IAB-donor-CU side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS 38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named Backhaul RLC Channel (BH RLC channel). This mainly concerns the interfaces between the IAB-nodes.

Thus, on each backhaul link, the BAP PDUs are carried by Backhaul (BH) RLC channels. Each BH RLC channel is configured with QoS information or priority level, and multiple BH RLC channels can be configured on each BH link to allow traffic prioritization and QoS enforcement. A BAP PDU contains data associated to a radio bearer setup to transport traffic flows, and each traffic flow has a specific QoS requirement, such as data rate, latency, packet error rate. Therefore, a radio bearer is mapped on a BH RLC channel corresponding to the desired QoS level. There can be a one-to-one (1:1) mapping with one radio bearer per RLC channel, but also a many-to-one (N:1) mapping where several radio bearers having similar QoS requirements are multiplexed over the same RLC channel. Furthermore, two BAP PDUs carrying two different radio bearers may have the same BAP Routing ID, but they may be transmitted over two different BH RLC channels when the radio bearers are not associated to the same QoS level.

In an IAB network, radio resources for the downstream/downlink and upstream/uplink transmissions on backhaul links (i.e. between an IAB-node and its child IAB-nodes), and on access links (i.e. between an IAB-node and the UEs served by the IAB-node) are scheduled by the IAB-node-DU itself (e.g. MAC scheduler). As a consequence, the downlink and uplink transmissions on a backhaul link between an IAB-node-MT and its parent IAB-node are scheduled by the parent IAB-node-DU (or IAB-donor-DU). The scheduler applies different data rates, packet error rates, etc. and scheduling weights (i.e. different priorities) to the BH RLC channels so as to respect the different QoS levels of BH RLC channels. Buffers or internal buffers at an IAB-node hold data before the data is selected by the MAC scheduler for transmission over a backhaul link. The status of the buffer (e.g. the available buffer size or buffer load) is monitored and reported to the MAC scheduler of the IAB-node DU so the scheduler can determine the amount of resources to grant. Buffer status may be reported per BH RLC channel or per BAP Routing ID. As BAP data packets with the same BAP Routing ID may have different QoS requirements, BAP data packets with the same BAP Routing ID may be transmitted on different BH RLC channels. Thus, the reporting per BH RLC channel is more accurate, but the resource overhead is greater.

As discussed in the introduction, release 16 for 5G NR defines a flow control mechanism that can be supported in IAB networks in both upstream and downstream directions. The flow control mechanism may be triggered by the detection of a congestion in the transmission path. The congestion may be due to bad radio link conditions leading to high packets retransmission rate, and thus to a reduction of the BH link capacity. Also, the congestion may be due to an increase of the application data rate affecting one or several radio bearers. In the downstream direction, flow control is supported on BAP sublayer, where the IAB-node (IAB-MT) can send feedback information in flow control feedback on the available buffer size for an ingress BH RLC channel ID or BAP routing ID to its parent IAB-node. Then, the scheduler in the parent IAB-node (i.e. the IAB-DU of the parent IAB-node) may reduce the downlink data rate for a particular BH RLC channel or BAP routing ID to alleviate a reported congestion. In the upstream direction, flow control may be directly supported at the IAB-node through the uplink scheduling by the IAB-DU of the IAB-node and a reduction of uplink data rate (by reducing the allocation of resources for uplink transmissions). The current 5G NR specifications only consider flow control feedback sent to a parent IAB-node (for a downstream congestion).

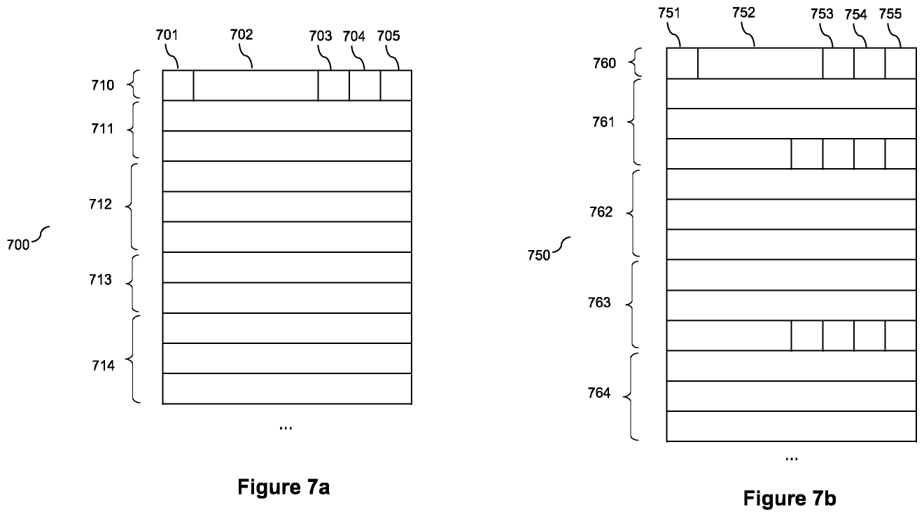

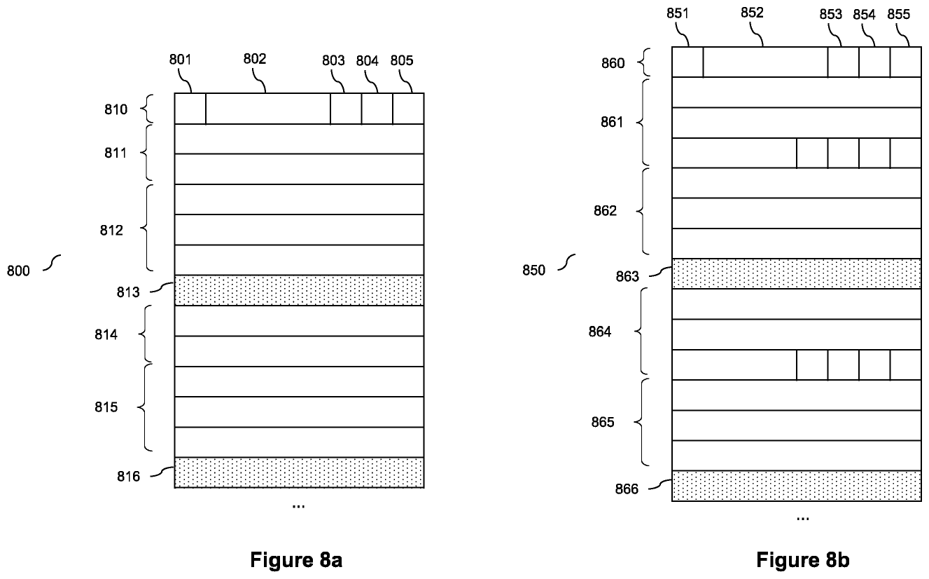

However, as discussed below, the IAB-node (IAB-DU) may also send feedback information in flow control feedback on the available buffer size at the IAB-node (for an ingress BH RLC channel ID or BAP routing ID) to its child IAB-node (for an upstream congestion). The format for flow control feedback is discussed below with reference to FIGS. 7a, and 7b and FIGS. 8a, and 8b. Typically, flow control feedback is provided by an IAB-node when a flow control feedback is triggered due to the buffer load exceeding a certain level or when a BAP control PDU for flow control polling is received from a parent IAB-node (or from a child IAB-node).

NR-Uu is the interface between the UE and the radio access network, i.e. its access IAB-node (for both CP and UP).

FIG. 2b comes from 3GPP TS 38.300 v16.4.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes Signalling Radio Bearers SRBs (bearers carrying RRC and NAS messages) with the IAB-donor-CU. These SRBs are transported between the IAB-MT and its parent node(s) over NR-Uu interface(s).

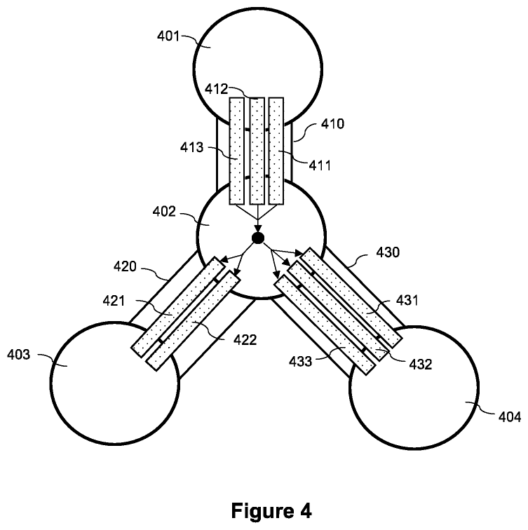

FIG. 4 illustrates a routing management in an IAB network. The routing management at an IAB-node acting as relay is based on a BAP routing configuration and seeks to determine, from one BH RLC channel of an ingress link (also referred to as ingress backhaul link) over which a BAP packet is received, one BH RLC channel of one egress link (also referred to as egress backhaul link) for forwarding the received BAP packet.

A BAP routing configuration may be set manually in each IAB-node of the IAB network. Preferably, the BAP routing configurations are built and can be updated over time by the IAB-donor-CU and transmitted by same via F1AP signalling to the IAB-nodes during their initial configuration and the life of the IAB network. As mentioned above, the BAP routing configurations may be built by IAB-donor-CU based on the IAB network topology and its evolution over time (e.g. should some radio links disappear or recover or their link quality changes).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.4.0, section 6.11.3 for the BAP sublayer. It is used by the IAB-node to select the egress link to forward or transmit a BAP packet or PDU (Protocol Data Unit) to a next hop IAB-node.

Field 501 defines a BAP Routing ID (concatenation of the DESTINATION and PATH fields 305, 306 mentioned above with reference to FIG. 3) while field 502 specifies the next-hop BAP Address, i.e. the BAP address of the next hop IAB-node or next IAB-node along the path corresponding to the Routing ID 501. The Next Hop BAP address 502 thus identifies an egress link to forward or transmit the BAP packet. Next-hop BAP address and egress link are synonymous because they each designate the same portion (radio link or backhaul link) of the IAB network between the current IAB-node (e.g. the intermediate or relay IAB-node) and the next IAB-node (e.g. the next hop IAB-node) having the next-hop BAP address. Consequently, they can be used interchangeably to designate such IAB network radio link or backhaul link.

There may be several entries in the Backhaul Routing Configuration table with the same destination BAP address but with different Path IDs and next-hop BAP Addresses in the information element 502. The first entry may provide the default next-hop BAP Address corresponding to the default path to reach the destination, and the other entries with the same destination BAP address relate to back-up redundant paths to be selected when the default link is not available, e.g. because of radio link failure (RLF) or congestion.

FIG. 5b schematically shows an entry 510 of the BH RIC channel mapping configuration table as defined in 3GPP TS 38.300, section 6.11.3 and/or 3GPP TS 38.340, V16.3.0, section 5.2.1.4.1, for the BAP sublayer. It is used by the IAB-node acting as a relay (e.g. an intermediate or relay IAB-node) to identify the BH RLC channel to be used for forwarding a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node (or prior hop IAB-node) from which the BAP packet to route arrives; IE 513 specifies an ingress BH RLC channel ID, i.e. the identifier of a BH RLC channel over which the BAP packet to route is received; and IE 514 stores an egress BH RLC channel ID providing the BH RLC channel the IAB-node will use to forward the BAP packet.

Prior-hop BAP address and ingress link are synonymous because they each designate the same portion (radio link or backhaul link) of the IAB network between the current IAB-node (e.g. the intermediate or relay IAB-node) and the prior IAB-node (e.g. the prior hop IAB-node) having the prior-hop BAP address. Consequently, they can be used interchangeably to designate such IAB network radio link or backhaul link.

Note that for BH RLC channels in the downstream direction (parent to child direction, e.g. IAB-node 402 towards IAB-node 403 in FIG. 4), the BH RLC channel ID is included in the F1AP configuration of the BH RLC channel provided by the IAB-donor CU. For BH RLC channels in the upstream direction (child to parent direction, e.g. IAB-node 402 towards IAB-node 401), the BH RLC channel ID is included in the RRC configuration of the corresponding logical channel provided by the IAB-donor CU.

FIGS. 5c and 5d illustrates the equivalents to the BH RIC channel mapping configuration table for the IAB-node that does not act as intermediate IAB relaying entity. They are defined in 3GPP TS 38.340, sections 5.2.1.4.2 and section 5.2.1.4.3.

The table in FIG. 5c is called Uplink Traffic to BH RLC Channel Mapping Configuration table, 520. It is used by an initiator IAB-node (not the IAB-donor-DU) having built BAP packets or PDUs from BAP SDUs (Service Data Unit) received from upper layers, to identify the BH RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel providing the BH RLC channel the IAB-node will use to transmit the BAP packet.

The table in FIG. 5d is called Downlink Traffic to BH RLC Channel Mapping Configuration table 530. It is used by the IAB-donor-DU having built BAP packets or PDUs from BAP SDUs (Service Data Unit) received from upper layers, to identify the BH RLC channel to transmit these BAP packets in downstream direction over the egress link previously selected using the Backhaul Routing Configuration table.

IE 531 is an IPV6 flow label used to classify IPV6 flows, IE 532 specifies a DSCP (Differentiated Services Code Point) usually indicated in the IPV6 header of the packets, IE 533 indicates a destination IP Address, IE 534 indicates a next-hop BAP Address as defined above, and IE 535 defines an egress BH RLC channel ID providing the BH RLC channel the IAB-node will use to transmit the BAP packet.

The tables of FIGS. 5b, 5c and 5d may be composed of several rows (entries), each row/entry including the IEs shown in the respective Figures.

As a result of all the tables configured in the IAB-nodes and more particularly the Routing IDs of IEs 501, multiple BAP paths are defined through multiple IAB-nodes.

Back to FIG. 4, the routing of a BAP packet by the BAP sublayer of IAB-node 402 uses the BAP routing ID 305+306 of a BAP packet. The BAP address (DESTINATION path 305) is used for the purpose of:
1) determining whether the BAP packet has reached the destination node, i.e. IAB-node or IAB-donor-DU, on BAP sublayer. The BAP packet has reached its destination node if the BAP address 305 in the packet's BAP header matches the BAP address configured either via RRC on the IAB-node or via F1AP on the IAB-donor-DU.
2) determining the next-hop IAB-node for the BAP packet that has not reached its destination. This applies to BAP packets arriving from a prior-hop IAB-node over the BAP sublayer or arriving from upper layers.

For packets arriving from a prior-hop IAB-node or from upper layers, the determination of the next-hop IAB-node is based on the entries of the Backhaul Routing Configuration table 500.

The IAB-node 402 resolves the next-hop BAP address 502 to a physical backhaul link, being either link 420 or link 430 (i.e. an egress backhaul link or egress BH link). To that end, it seeks the entry in the table 500 having field 501 matching the BAP Routing ID 305+306 of the BAP packet. Corresponding field 502 provides the next-hop BAP address.

The Backhaul Routing Configuration table 500 may have multiple entries with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF) or congestion, the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate or relay IAB-node transmitting in upstream or downstream direction, initiator IAB-node transmitting in upstream direction, or IAB-donor-DU transmitting in downstream direction).

For instance, for an intermediate or relay IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in the upstream direction to the IAB-donor, IEs 521, 522 are the inputs and IE 523 is the output of the BH RLC channel look-up process: the IAB-node 402 selects the egress BH RLC Channel 523 corresponding to the table 520 entry where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For an IAB-donor-DU wishing to transmit a BAP packet in the downstream direction to a destination IAB-node or an UE, IEs 531, 532, 533, 534 are the inputs and IE 535 is the output of the BH RLC channel look-up process: the IAB-donor-DU selects the egress BH RLC Channel 535 corresponding to the table 530 entry matching the Destination IP address 533, the IPV6 Flow Label 531 (only for BAP SDU encapsulating an IPV6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets). If there is no matching entry, the selection of one egress BH RLC channel ID is up to implementation.

A BH RLC channel ID is generated by the IAB-donor-CU and it has link-local scope only, meaning that it uniquely identifies a BH RLC channel within a backhaul link between two IAB-nodes. Thus, the BH RLC channel IDs identifying the BH RLC channels 411, 412, and 413 on the BH link 410 are all different identifiers. Similarly, the BH RLC channel IDs identifying the BH RLC channels 421 and 422 on the BH link 420 are all different identifiers, and the BH RLC channel IDs identifying the BH RLC channels 431, 432, and 433 on the BH link 430 are all different identifiers. However, the same identifier may be reused for two different links, with, for instance, the BH RLC channel ID of BH RLC channel 411 having the same value as the BH RLC channel ID of BH RLC channel 433. Furthermore, two BH RLC channels conveying the same BAP PDU over two different BH links may have a different identifier. For instance, a BAP PDU received on BH RLC channel 411 in the BH link 410 may be routed to the BH RLC channel 431 in the BH link 430, where the BH RLC channel ID of BH RLC channel 411 is different from the BH RLC channel ID of BH RLC channel 431.

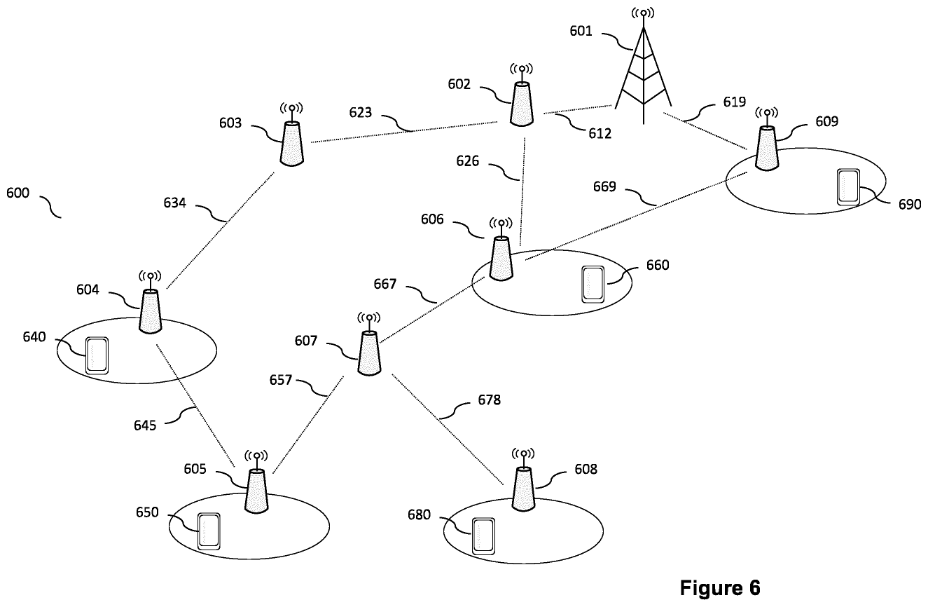

FIG. 6 illustrates an example topology of an IAB network arrangement in which embodiments and examples of embodiments of the present invention may be implemented. In one example implementation, the BH radio links are operated over the millimeter wave frequency band (i.e. above 30 GHz), which is highly sensitive to radio channel disturbance.

IAB topology 600 includes IAB-donor 601 (composed of both an IAB-Donor-CU and an IAB-Donor-DU and similar to IAB-node 120 of FIG. 1), and a plurality of IAB-nodes 602, 603, 604, 605, 606, 607, 608, and 609, similar to IAB-nodes 121 and 122.

IAB-node 602 is connected to the parent IAB-donor-DU 601 through BH link 612, to the child IAB-node 603 through BH link 623, and to the child IAB-node 606 through BH link 626. IAB-node 603 is further connected to the child IAB-node 604 through BH link 634, which is itself connected to the child IAB-node 605 through BH link 645. IAB-node 609 is connected to the parent IAB-donor-DU 601 through BH link 619, and to the child IAB-node 606 through BH link 669. IAB-node 606 is further connected to the child IAB-node 607 through BH link 667, which is itself connected to the child IAB-node 605 through BH link 657, and to the child IAB-node 608 through BH link 678.

IAB-nodes 604, 605, 606, 608, 609 are respectively serving UEs 640, 650, 660, 680, and 690, and thus, they also act as access IAB-nodes for the respective UEs.

Redundant paths may exist between pairs of IAB-nodes, for instance, regarding downstream paths from IAB-donor-DU 601 to IAB-node 605:
a first default BAP path, PATH 1, associated with BAP Routing ID 1, via IAB-nodes 602, 606, and 607, and through the BH links 612, 626, 667, and 657,
a second BAP path, PATH 2, associated with BAP Routing ID 2, via IAB-nodes 602, 603, 604, and 605, and through the BH links 612, 623, 634, and 645,
a third BAP path, PATH 3, associated with BAP Routing ID 3, via IAB-nodes 609, 606, and 607, and through the BH links 619, 669, 667, and 657.

Symmetrically, three upstream paths may also be defined with the same involved devices and BH links from IAB-node 605 to IAB-donor-DU 601.

In an example scenario for such a downstream path from IAB-donor DU 601 to IAB-node 605, BH radio link 657 between IAB-node 605 and IAB-node 607 may experience radio link deficiency due to some unexpected interference or shadowing phenomena. Thus, the capacity of this BH link may be lower than expected (e.g. radio link deficiency leading to high packets retransmission rate), and a congestion may occur in IAB-node 607 leading to prefer the PATH 2 to transmit BAP PDUs down to IAB-node 605. It may happen that the congestion occurs for only some and not all of BH RLC channels of BH link 657, because of a high load (i.e. high application data rate) and/or a lower priority of these BH RLC channels compared to other BH RLC channels of the BH link 657 with lower load and/or having higher priority. In such a case, the load of the buffers for the BH RLC channels with high load and/or lower priority will be greater compared to the load of the buffers for the BH RLC channels with lower load and/or higher priority. The congestion may concern the BAP PDUs associated to one or several BAP Routing IDs.

In the downstream direction the IAB-MT of the IAB-node 607 receives BAP PDUs from the IAB-DU of the IAB-node 606 and the IAB-MT writes the received BAP PDUs in internal buffers for further transmission by the IAB-DU of IAB-node 607 to the child IAB-node 605. Each RLC channel of the BH link 657 may have an associated buffer and each of the received BAP PDUs is written to the buffer associated with the BH RLC channel over which the BAP PDU is transmitted. An indication of possible congestion at the IAB-node 607 may be detected when the IAB-node 607 detects an increase of a buffer load at one or more of the buffers and in response, the scheduler in IAB-node-DU 607 may try to reduce the data rate in the downstream direction for one or more BH RLC channels associated with the one or more of the buffers. In case the IAB-node 607 detects a buffer load exceeding a certain level for one or several buffers associated with respective one or several BH RLC channels in the downstream direction (i.e. toward IAB-node 605), the IAB-node 607 may try to reroute, using a configured alternative path and based on the BAP routing ID in the header of the BAP PDUs, the BAP PDUs carried over the BH link 657 at least for the BH RLC channels with a buffer overload. However, such downstream alternative path to IAB-node 605 does not exist from this IAB-node 607. Therefore, IAB-node 607 (e.g. the IAB-MT of IAB-node 607) may send a flow control feedback to its parent IAB-node(s) (i.e. to IAB node 606 in this example), with one of the message formats described in the FIGS. 7a, 7b, 8a and 8b. The flow control feedback contains status information relative to buffer load (e.g. available buffer size) in IAB-node 607, either per BH RLC Channel ID or per BAP routing ID. The flow control feedback is sent on the egress link 667 over a BH RLC channel configured in advance by the IAB-donor-CU 601 (for example, see TS 38.340, section 5.3.1).

FIG. 7a is a schematic diagram illustrating a first format 700 of a flow control feedback per BH RLC channel. It is a BAP Control PDU specified in the standardized version paragraph 6.2.3 of 3GPP TS 38.340 version 16.3.0.

The header 710 includes fields 701 to 705. Field 701, named D/C field, is a Boolean indicating whether the corresponding BAP packet is a BAP Data packet or a BAP Control packet. Field 702 is a 4-bit value coding the PDU type (i.e. a flow control feedback per BH RLC channel), the fields 703-705 are 1-bit reserved fields, preferably set to 0 (to be ignored by the receiver).

Fields 711 and 712 indicate together the status of the buffer load associated to a first BH RLC channel. Field 711 also referred to as BH RLC channel ID field is the 16-bit unique identifier of the reported BH RLC channel. The 24-bit field 712 indicates the size in Bytes of the available buffer size for the reported BH RLC channel. Fields 713 and 714 are equivalent to fields 711 and 712 for a second BH RLC channel. There may be other fields like 711 and 712 to report the status for other BH RLC channels without limitation in the number.

FIG. 7b is a schematic diagram illustrating a first format 750 of a flow control feedback per BAP routing ID. It is a BAP Control PDU specified in the standardized version paragraph 6.2.3 of 3GPP TS 38.340 version 16.3.0.

The header 760 includes fields 751 to 755. Field 751, named D/C field, is a Boolean indicating whether the corresponding BAP packet is a BAP Data packet or a BAP Control packet. Field 752 is a 4-bit value coding the PDU type (i.e. a flow control feedback per BAP Routing ID), the fields 753-755 are 1-bit reserved fields, preferably set to 0 (to be ignored by the receiver).

Fields 761 and 762 indicate together the status of the buffer load associated to a first BAP routing ID. Field 761 is composed of the BAP routing ID field (20 bits) padded with 4×1-bit reserved fields. The 24-bit field 762 indicates the size in Bytes of the available buffer size for the reported BAP routing ID. Fields 763 and 764 are equivalent to fields 761 and 762 for a second BAP routing ID. There may be other fields like 761 and 762 to report the status for other BAP routing IDs without limitation in the number.

The choice between a feedback per BH RLC channel ID or per BAP routing ID may be up to implementation.

As BAP PDUs with the same BAP routing ID may be transmitted over different BH RLC channels, the available buffer size for a BAP routing ID may be the lowest value of the available buffer sizes for all of the buffers associated with the different BH RLC channels, or the sum or the average of the available buffer sizes.

FIG. 8a is a schematic diagram illustrating a second format 800 of a flow control feedback per BH RLC channel. It is an enhancement of the format 700 of FIG. 7a with the fields 801, 802, 803, 804, 805, 810, 811, 812, 814 and 815 equivalent to the fields 701, 702, 703, 704, 705, 710, 711, 712, 714 and 715. For each reported BH RLC channel, a new field (813 or 816) referred to as BH Radio Quality, is added to report the radio quality of the backhaul path (e.g. the path identified by a path identifier (ID) in the BAP routing ID) associated to the BH RLC channel. A field like 813 and 816 may be an 8-bit index value representative of the SINR (Signal-to-interference-plus-noise ratio) level, or any other quality metric, such as the data packet loss or the average number of retransmissions per data packets. The one skilled in the art may easily identify other radio path quality metrics that could be reported in the flow control feedback.

FIG. 8b is a schematic diagram illustrating a second format 850 of a flow control feedback per BAP routing ID. It is an enhancement of the format 750 of FIG. 7b with the fields 851, 852, 853, 854, 855, 860, 861, 862, 864 and 865 equivalent to the fields 751, 752, 753, 754, 755, 760, 761, 762, 764 and 765. For each reported BAP routing ID, a new field (863 or 866) referred to as BH Radio Quality, to report the backhaul radio quality of the backhaul path associated to the BAP routing ID. A field like 813 and 816 may be an 8-bit index value representative of the SINR (Signal-to-interference-plus-noise ratio) level, or any other quality metric, such as the data packet loss or the average number of retransmissions per data packets. The one skilled in the art may easily identify other radio path quality metrics that could apply.

The choice between a feedback with BH radio quality per BH RLC channel ID or per BAP routing ID may be up to implementation.

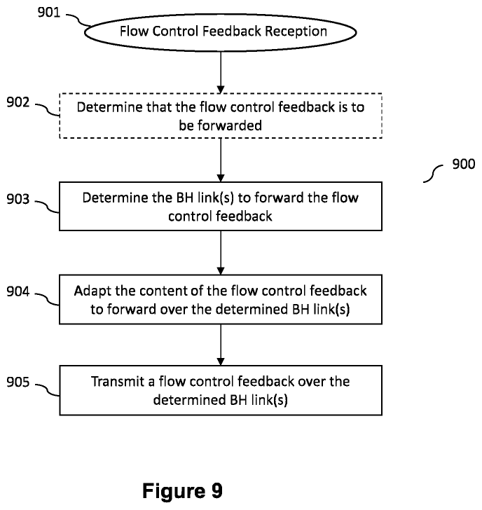

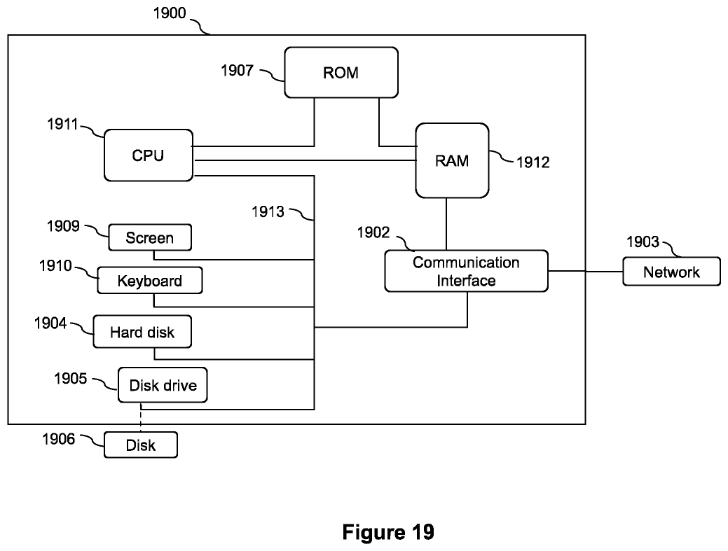

FIG. 9 shows steps of a method 900, performed at an IAB-node, for processing (and forwarding) a flow control feedback in an IAB network in accordance with an embodiment of the invention. The flow control feedback is received from a child or a parent IAB-node. The IAB-node may be implemented in a communication device 1900 as shown in FIG. 19 below with the method as shown in FIG. 9 being performed by the central processing unit 1911. The IAB-node may be one of the IAB-nodes 602, 603, 604, 605, 606, 607, 608, 609 or the IAB-donor-DU 601. In the following, it is assumed that the IAB-node is IAB-node 606 and flow control feedback may be received at the IAB-node 606 from a child IAB-node (e.g. from IAB-node 607) for downstream communications or flow control feedback may be received at the IAB-node 606 from a parent IAB-node (e.g. from IAB-node 602) for upstream communications.

In step 901, the IAB-node 606 receives over an egress backhaul link or BH link between the IAB-node 606 and another IAB-node (such as from IAB-node 607 over egress BH link 667 for downstream communications or from IAB-node 602 over egress BH link 626 for upstream communications) a flow control feedback. The flow control feedback comprises link identification information (e.g. link identification information associated with the egress backhaul link). The link identification information may include backhaul RLC channel identifier(s) for identifying one or several backhaul RLC channel(s) of the egress backhaul link or routing identifier(s) (e.g. BAP routing ID(s)) for identifying one or several routing path(s) for routing data in the IAB network to a destination IAB node. The flow control feedback may have one of the formats described in the FIGS. 7a, 7b, 8a and 8b. The flow control feedback may be transmitted by the another IAB-node in response to a flow control polling request sent by the IAB-node 606 as the parent IAB node or may be transmitted in response to detecting congestion (e.g. available buffer size is less than a predetermined congestion threshold) for at least one buffer associated with a BH RLC channel or a BAP routing identifier. The backhaul link on which the flow control feedback is received (e.g. the egress BH link) is indicated by the lower layers (from the MAC sublayer), and may be stored with the corresponding address (e.g. the BAP address) of the IAB-node connected through this link. The correspondence between a BH link and the BAP address connected through this link is configured by the IAB-donor-CU controlling the IAB network (e.g. IAB-donor-CU 601).

In step 902 (shown in dotted lines), the IAB-node 606 may determine that the flow control feedback is to be forwarded. The decision may be based on a configuration provided by the IAB-donor CU. An IAB-node may systematically always forward a received flow control feedback. According to another example, the IAB-node 606 may estimate if the flow control feedback indicates a situation of congestion with the need to attempt a corrective action, for instance, if the available buffer size for a BH RLC channel (or BAP routing ID) is below a predetermined threshold (or certain level) or a load in a buffer in another IAB node based on the flow control feedback has exceeded a congestion threshold. For such flow control feedback, the IAB-node 606 may decide to forward it immediately or it may evaluate the feasibility of a local corrective action like a data rate adaptation in the scheduler of the IAB-node 606 or packets rerouting on an alternative path. When no corrective action can be implemented or can be efficiently implemented or applied, the IAB-node 606 then decides to forward the flow control feedback. The determination according to step 902 may take place at any point in the flow shown in FIG. 9 before step 905.

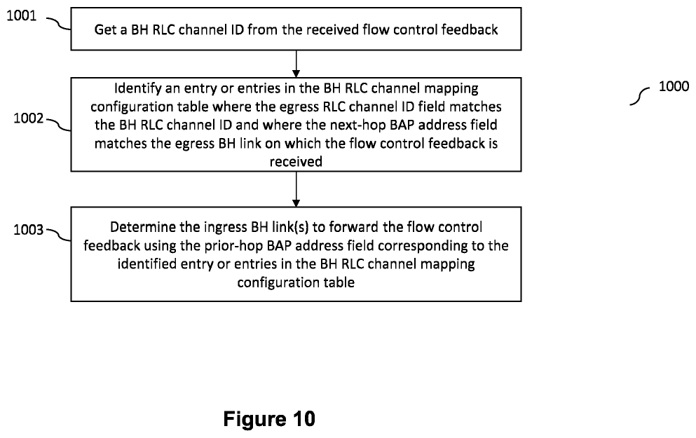

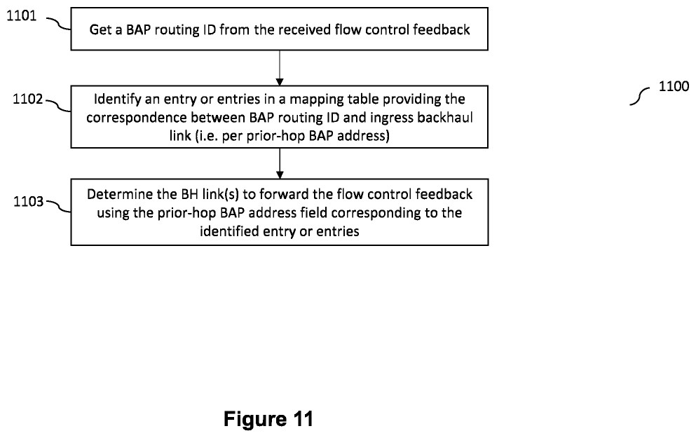

In step 903, the IAB-node 606 determines or selects at least one ingress backhaul link, the BH link(s), to forward the flow control feedback. According to a first example, a flow control feedback received on a BH link (e.g. egress BH link) on the IAB-DU side (i.e. from a child IAB-node) will be forwarded on all the BH links (e.g. all the ingress BH links) on the IAB-MT side (i.e. to all the parent IAB-nodes), and a flow control feedback received on a BH link (e.g. egress BH link) on the IAB-node-MT side (i.e. from a parent IAB-node) will be forwarded on all the BH links (e.g. all the ingress BH links) on the IAB-DU side (i.e. to all the child IAB-nodes). According to another embodiment, the determination or selection is performed based on the link identification information (e.g. BH RLC channel identifier or routing identifier) included in the flow control feedback. For example, the determination may be performed according to one of the flowcharts described below with reference to FIG. 10 and FIG. 11 where the determination of BH link(s) is refined in order to forward the flow control feedback only to the IAB-nodes concerned by the reported BH RLC channel IDs (FIG. 10) or BAP routing IDs (FIG. 11). When checking whether there is a backhaul link to forward the flow control feedback, no ingress BH link may be determined meaning that the flow control feedback is not forwarded. This may be the case for instance for an IAB-node at the edge of the IAB topology, like IAB-nodes 605, 608 or the IAB-donor-DU 601 in FIG. 6. It may also be the case for an IAB-node generating the BAP PDUs (e.g. an initiator IAB-node) with the BAP routing IDs reported in the flow control feedback or carried over the reported BH RLC channels.

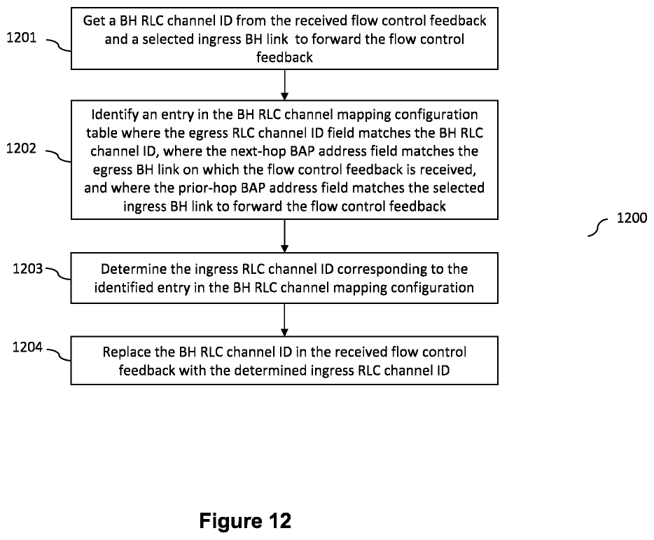

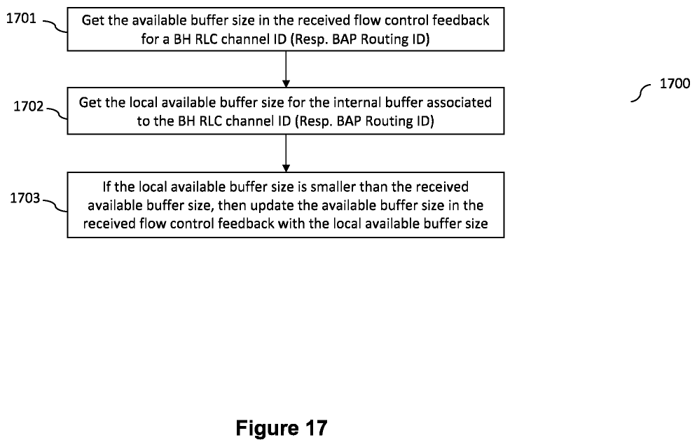

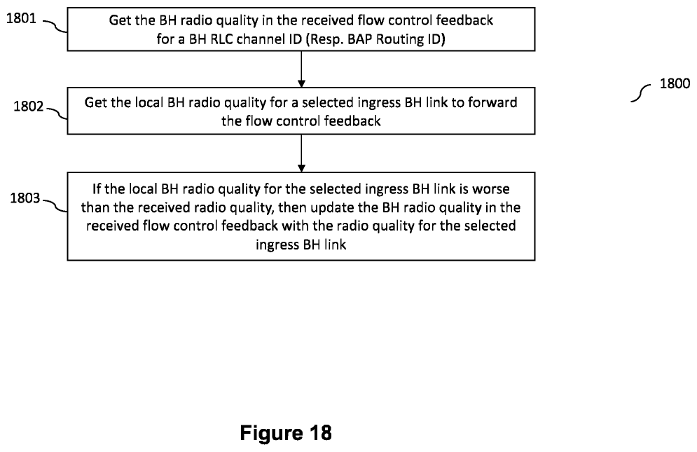

In step 904, the IAB-node 606 may update or adapt the content of (also referred to as information included in) the received flow control feedback for the determined BH link(s) to provide an updated flow control feedback before forwarding. For example, the IAB-node 606 may update or adapt link identification information, such as the BH RLC channel ID(s), in the received flow control feedback and/or status information, such as available buffer size and/or radio quality, in the received flow control feedback. The IAB-node 606 may update information included in the received flow control feedback for the determined BH link(s) based on the link identification information (e.g. the BH RLC channel ID(s) or the BAP routing ID(s)) to provide an updated flow control feedback. In particular, it may adapt the BH RLC channel IDs in the flow control feedback as described with reference to FIG. 12 below in case of a flow control feedback per BH RLC channel, and/or it may adapt status information in the flow control feedback such as the available buffer size as described with reference to FIG. 17 below in case of a flow control feedback per BH RLC channel or per BAP routing ID, and/or it may adapt the BH radio quality as described with reference to FIG. 18 below in case of a flow control feedback per BH RLC channel or per BAP routing ID.

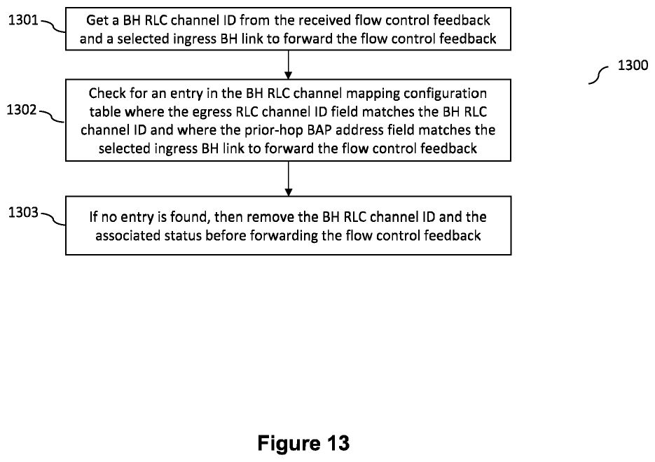

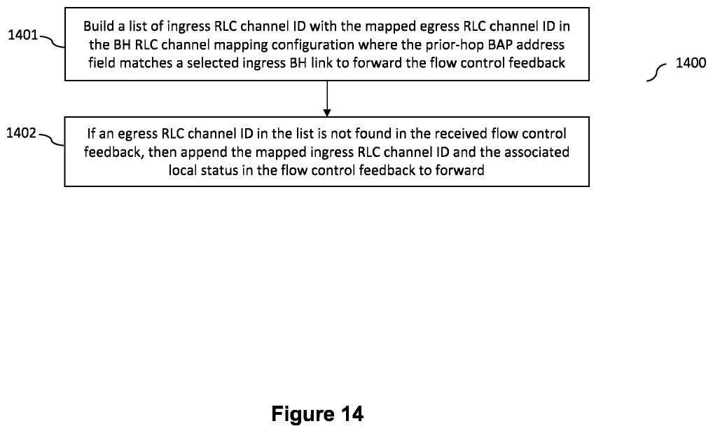

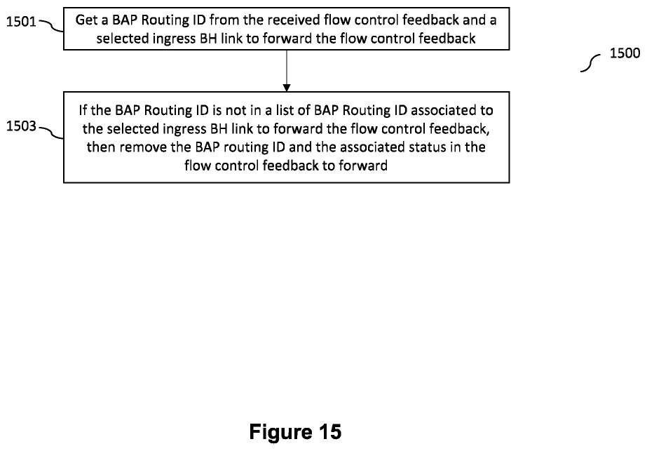

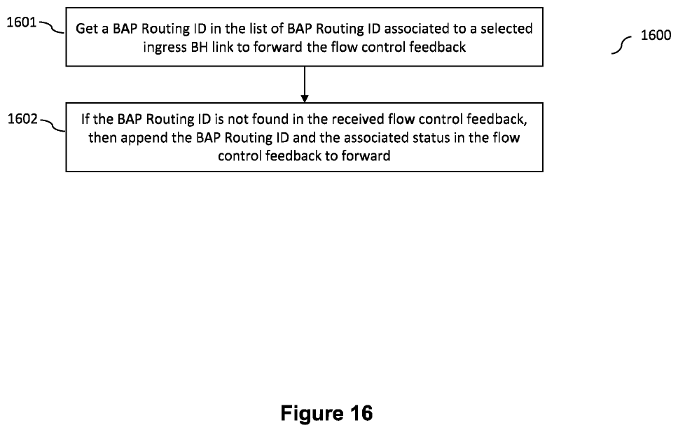

In addition, the IAB-node 606 may update information included in the received flow control feedback by removing one or several BH RLC channel IDs status (FIG. 13) or one or several BAP routing IDs status (FIG. 15) when the targeted IAB-node (e.g. the prior hop IAB-node to which the flow control feedback is to be forward) is not concerned by these BH RLC channel IDs or BAP routing IDs. Finally, the IAB-node 606 may update information included in the received flow control feedback by appending one or several BH RLC channel IDs status (FIG. 14) or one or several BAP routing IDs status (FIG. 16) when the targeted IAB-node is concerned by these BH RLC channel IDs or BAP routing IDs not reported in the received flow control feedback. It is noted that when the flow control feedback includes routing identifiers (e.g. according to the format shown in FIG. 7b or 8b), the routing identifiers in the flow control feedback do not need to be updated before the flow control feedback is forwarded.

In step 905, the IAB-node 606 transmits (e.g. forwards) a flow control feedback (e.g. the updated flow control feedback) over the selected or determined BH link(s) (e.g. over the BH RLC channel configured (in advance) by the IAB-donor-CU).

Thus, in the example scenario mentioned above, when a flow control feedback is received by an IAB-node, such as IAB-node 606, it executes the steps described above with reference to the FIG. 9, and it may execute all or a part of the steps described in relation to FIGS. 10 to 18. For example, the IAB-node 606 may try to reroute the BAP PDUs transmitted on the BH link 667 over the BH RLC channels reported with a buffer overload, or with the BAP routing IDs reported with a buffer overload. Having no downstream alternative path, the IAB-node 606 may decide to forward the flow control feedback to its own parent IAB-nodes (i.e. IAB-nodes 602 and 609). Before forwarding, the IAB-node 606 may update the content of the flow control feedback to provide updated status information, and if required, updated BH RLC link identifiers, useful for the parent IAB-nodes 602. In particular, it may adapt or update the BH RLC channel IDs in case of a flow control feedback per BH RLC channel, and it may adapt or update the buffer load information according to its own buffer load status. Still in this example, the IAB-node 602 receiving the flow control feedback from IAB-node 606 may decide to reroute the BAP PDUs transmitted on link 626 over the BH RLC channels reported with a buffer overload, or with the BAP routing IDs reported with a buffer overload. In case the IAB-donor-CU has configured the alternative PATH 2, the IAB-node 602 will be able to reroute the BAP PDUs with BAP routing ID 1 through the alternative PATH 2. The effect will be to reduce the downstream data rate in the child IAB-nodes along the PATH 1 and it may efficiently alleviate the congestion detected in IAB-node 607.

With another example, a congestion in the upstream direction may be detected in IAB-node 603 by the IAB-DU writing BAP PDUs in internal buffers for transmission by the IAB-MT on the BH link 623 to the parent IAB-node 602. In the same manner as for the downstream congestion example, IAB-node 603 may send a flow control feedback to its child IAB-node 604, which may forward it to the IAB-node 605, and IAB-node 605 is able to reroute some BAP PDUs from the BH link 645 to the BH link 657 to reach the destination IAB-node 602 through the BH links 667 and 626. Before forwarding, the IAB-node 604 may update the content of the flow control feedback to provide updated status information, and if required, updated BH RLC link identifiers, useful for the IAB-node 605.

FIG. 10 illustrates, using a flowchart, an exemplary method of determining or selecting at least one ingress backhaul link, the BH link(s), to forward a flow control feedback per BH RLC channel by an IAB-node according to embodiments and examples of the invention. The IAB-node may be implemented in a communication device 1900 as shown in FIG. 19 below with the method as shown in FIG. 11 being performed by the central processing unit 1911. The IAB-node may be one of the IAB-nodes 602, 603, 604, 605, 606, 607, 608 or the IAB-donor-DU 601. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises at least one backhaul RLC channel identifier for identifying a backhaul RLC channel of the egress backhaul link and may have the format as shown in FIGS. 7a and 8a. The IAB node 606 is configured with backhaul RLC channel mapping configuration information (for example, BH RLC channel mapping configuration table 510 as described above with reference to FIG. 5b) for mapping backhaul RLC channel identifiers from egress to ingress backhaul links.

Briefly, in step 1001, the IAB-node 606 gets or identifies a BH RLC channel identifier (ID) from the received flow control feedback (e.g. field 711 in FIG. 7a or field 811 in FIG. 8a). In step 1002, the IAB-node 606 identifies an entry or entries in the BH RLC channel mapping configuration table 510 (in FIG. 5) where the egress BH RLC channel ID field 514 matches the BH RLC channel ID (obtained or identified in step 1001) and where the next-hop BAP address field 511 matches the BH link or egress BH link on which the flow control feedback is received (for example, where the next-hop BAP address field 511 matches the address of the IAB node (IAB-node 607 or 602) from which the flow control feedback is received over the egress BH link). In step 1003, the IAB-node 606 determines the BH link(s) (e.g. at least one ingress BH link) to forward the flow control feedback using the prior-hop BAP address field 512 corresponding to the identified entry or entries in the BH RLC channel mapping configuration table 510. Several BH links may be selected or determined in case the IAB-node is connected to several parent IAB-nodes. Indeed some BAP PDUs received from two different parent IAB-nodes (such as from IAB-nodes 602 and 609 for IAB-node 602) may be routed on an egress BH link over the same BH RLC channel (such as BH link 667 to IAB-node 607). Therefore, the flow control feedback for the BAP PDUs routed on the egress BH link may be forwarded on several BH links (e.g. ingress BH link 626 to IAB-node 602 and ingress BH link 669 to IAB-node 609).

The steps 1001, 1002, and 1003 are repeated for each BH RLC channel ID reported in the received flow control feedback. Thus, for an intermediate or relay IAB-node at least one ingress BH link is determined for each of the BH RLC channel IDs.

FIG. 11 illustrates, using a flowchart 1100, an exemplary method of determining or selecting at least one ingress backhaul link, the BH link(s), to forward a flow control feedback per BAP routing ID by an IAB-node according to embodiments and examples of the invention. The IAB-node may be implemented in a communication device 1900 as shown in FIG. 19 below with the method as shown in FIG. 11 being performed by the central processing unit 1911. The IAB-node may be one of the IAB-nodes 602, 603, 604, 605, 606, 607, 608 or the IAB-donor-DU 601. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises at least one routing identifier (e.g. at least one BAP routing identifier (ID) as described above with reference to FIG. 3) and may have the format as shown in FIGS. 7b and 8b. The IAB-node 606 is provided with mapping information for mapping at least one BAP routing ID to at least one ingress backhaul link at the IAB-node 606. The mapping information may comprise a mapping table providing correspondence between BAP routing ID and ingress backhaul link (i.e. per prior-hop BAP address). Each entry of the mapping table has a BAP routing identifier field for a BAP routing identifier and a prior hop address field for an address of an IAB-node that is prior to the IAB node 606 in the routing path identified by the BAP routing identifier. The mapping information/table may be configured by the donor CU or the IAB-node 606 may generate or build the mapping information/table over time as it routes data between its parent node(s) and its child IAB-node(s).

Briefly, in step 1101, the IAB-node 606 gets or identifies a BAP routing ID from the received flow control feedback (e.g. 761 in FIG. 7b or 861 in FIG. 8b). In step 1102, the IAB-node 606 identifies an entry or entries in a mapping table providing the correspondence between BAP routing ID and ingress backhaul link (i.e. per prior-hop BAP address). This table is not specified by a 3GPP document, however, as discussed above, it may be an additional table configured by the IAB-donor-CU or it may be built by the IAB-nodes on the fly. When routing a BPA PDU received on an ingress BH link, the IAB-node 606 may store the BAP routing ID of the BAP PDU in this table. The correspondence between an ingress BH link and the BAP address connected through this link (i.e. prior-hop BAP address) is configured by the IAB-donor-CU. There may be several entries with the same BAP routing ID in case a rerouting was performed and BAP PDUs with the same BAP routing ID have been received from two different ingress BH links. If a BAP routing ID has not been detected on an ingress link during some time (e.g. after a few minutes), the corresponding entry may be cleared in the table. In step 1103, the IAB-node determines the BH link(s) (e.g. at least one ingress BH link) to forward the flow control feedback using the prior-hop BAP address field corresponding to the identified entry or entries.

The steps 1101, 1102, and 1103 are repeated for each BAP routing ID reported in the received flow control feedback. Thus, for an intermediate or relay IAB-node at least one ingress BH link is determined for each of the BH RLC channel IDs.

FIG. 12 illustrates, using a flowchart 1200, an exemplary method of updating a flow control feedback by updating or remapping link identification information, including a BH RLC channel ID, in the flow control feedback to provide an updated flow control feedback to be forwarded by an IAB-node acting as an intermediate or relay IAB-node according to embodiments of the invention. The intermediate IAB-node may be implemented in a communication device 1900 as shown in FIG. 19 below with the method as shown in FIG. 12 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises link identification information including at least one backhaul RLC channel identifier for identifying a backhaul RLC channel of the egress backhaul link and may have the format shown in FIGS. 7a and 8a. The IAB node 606 is configured with backhaul RLC channel mapping configuration information (for example, BH RLC channel mapping configuration table 510 as described above with reference to FIG. 5b) for mapping backhaul RLC channel identifiers from egress to ingress backhaul links. The IAB node 606 may use the backhaul RLC channel mapping configuration information to determine, for the at least one of the determined at least one ingress backhaul link, a backhaul RLC channel of the ingress backhaul link and to update information (i.e. the BH RLC channel identifier of the link identification information by remapping the BH RLC channel identifier according to its backhaul RLC channel mapping configuration information) in the flow control feedback as discussed below.

Briefly, in step 1201, the intermediate IAB-node 606 gets or identifies a BH RLC channel ID from the received flow control feedback (e.g. field 711 in FIG. 7a or field 811 in FIG. 8a) and a selected BH link (i.e. one of the determined at least one ingress BH link) to forward the flow control feedback (e.g. determined using the methods described above such as with reference to the flowchart of FIG. 10). In step 1202, the intermediate IAB-node 606 identifies an entry in the BH RLC channel mapping configuration table 510 where the egress RLC channel ID field 514 matches the identified BH RLC channel ID, where the next-hop BAP address field 511 matches the egress BH link on which the flow control feedback is received (for example, where the next-hop BAP address field 511 matches the address of the IAB node (IAB-node 607 or 602) from which the flow control feedback is received over the egress BH link), and where the prior-hop BAP address field 512 matches the selected/determined ingress BH link to forward the flow control feedback (for example, where the prior-hop BAP address field 512 matches the address of the IAB node (IAB-node 607 or 602) associated with the ingress BH link to be used for forwarding the flow control feedback). In step 1203, the intermediate IAB-node 606 determines the ingress BH RLC channel ID in the ingress BH RLC channel ID field 513 corresponding to the identified entry in the BH RLC channel mapping configuration table 510. In step 1204, the intermediate IAB-node 606 updates information included in the flow control feedback to provide an updated flow control feedback to be forwarded by updating the link identification information of the flow control feedback to replace the BH RLC channel ID for the egress BH link in the received flow control feedback with the determined ingress RLC channel ID for the ingress BH link. If no entry was found, the intermediate IAB-node 606 may update information included in the flow control feedback to provide an updated flow control feedback by removing the BH RLC channel ID for the egress BH link from the received flow control feedback as described by the FIG. 13.

The steps 1201, 1202, 1203, and 1204 are repeated for each BH RLC channel ID reported in the received flow control feedback and for each selected/determined ingress BH link to forward the flow control feedback.

FIG. 13 illustrates, using a flowchart 1300, an exemplary method for updating the flow control feedback by removing a BH RLC channel ID and associated status (also referred to as associated status information) in the flow control feedback to provide an updated flow control feedback to be forwarded by an IAB-node acting as an intermediate IAB-node according to embodiments of the invention. The intermediate IAB-node may be implemented in a communication device 1900 as shown in FIG. 19 below with the method as shown in FIG. 13 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises link identification information, including a backhaul RLC channel identifier for identifying a backhaul RLC channel of the egress backhaul link, and status information (which may be available buffer size and/or radio quality) for (or associated with) the backhaul RLC channel identified by the identified backhaul RLC channel identifier and may have the format shown in FIGS. 7a and 8a. The IAB node 606 is configured with backhaul RLC channel mapping configuration information (for example, BH RLC′ channel mapping configuration table 510 as described above with reference to FIG. 5b) for mapping backhaul RLC channel identifiers from egress to ingress backhaul links.

Briefly, in step 1301, the intermediate IAB-node 606 gets or identifies a BH RLC channel ID from the received flow control feedback (e.g. field 711 in FIG. 7a or field 811 in FIG. 8a) and a selected BH link (i.e. one of the determined at least one ingress BH link) to forward the flow control feedback (e.g. determined using the methods described above such as with reference to the flowchart of FIG. 10). In step 1302, the intermediate IAB-node 606 checks for an entry in the BH RLC channel mapping configuration table 510 where the egress BH RLC channel ID field 514 matches the BH RLC channel ID and where the prior-hop BAP address field 512 matches the selected/determined ingress BH link to forward the flow control feedback (for example, where the prior-hop BAP address field 512 matches the address of the IAB node (IAB-node 607 or 602) associated with the ingress BH link to be used for forwarding the flow control feedback). Then in step 1303, if no entry is found, the intermediate IAB-node 606 may update information included in the flow control feedback by removing the BH RLC channel ID (e.g. field 711 or field 811) and the associated status or associated status information (e.g. field 712 or fields 812 and 813) from the flow control feedback to provide an updated flow control feedback to be forwarded.

The steps 1301, 1302, and 1303 are repeated for each BH RLC channel ID reported in the received flow control feedback and for each selected/determined ingress BH link to forward the flow control feedback. Thus, in case of forwarding to several IAB-nodes, the content of the forwarded flow control feedback may be different for each targeted IAB-node. For example, when a flow control feedback includes a first backhaul RLC channel identifier for a first backhaul RLC channel of the egress backhaul link and first status information (which may be available buffer size and/or radio quality) for the first backhaul RLC channel, and a second backhaul RLC channel identifier for a second backhaul RLC channel of the egress backhaul link and second status information (which may be available buffer size and/or radio quality) for the second backhaul RLC channel, the information included in the flow control feedback for a first ingress backhaul link, determined based on the first BH RLC channel ID, is updated by removing the second backhaul RLC channel identifier and second status information for the second backhaul RLC channel to provide a first updated flow control feedback to be forwarded over the first ingress backhaul link. Furthermore, the information included in the flow control feedback for a second ingress backhaul link, determined based on the second BH RLC channel ID, is updated by removing the first backhaul RLC channel identifier and first status information for the first backhaul RLC channel to provide a second updated flow control feedback to be forwarded over the second ingress backhaul link.

FIG. 14 illustrates, using a flowchart 1400, an exemplary method for updating the flow control feedback by appending a BH RLC channel ID and associated status (also referred to as associated status information) in the flow control feedback to provide an updated flow control feedback to be forwarded by an IAB-node acting as an intermediate IAB-node according to embodiments of the invention. The intermediate IAB-node may be implemented in a communication device 1900 as shown in FIG. 19 below with the method as shown in FIG. 14 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises link identification information, including a backhaul RLC channel identifier for identifying a backhaul RLC channel of the egress backhaul link, and status information (which may be available buffer size and/or radio quality) for (or associated with) the backhaul RLC channel identified by the identified backhaul RLC channel identifier and may have the format shown in FIGS. 7a and 8a. The IAB node 606 is configured with backhaul RLC channel mapping configuration information (for example, BH RLC channel mapping configuration table 510 as described above with reference to FIG. 5b) for mapping backhaul RLC channel identifiers from egress to ingress backhaul links.

Briefly, in step 1401, the intermediate IAB-node 606 builds or provides a list of ingress RLC channel ID based on the mapped egress RLC channel ID in the BH RLC channel mapping configuration table 510 where the prior-hop BAP address field 512 matches the selected/determined ingress BH link to forward the flow control feedback (for example, where the prior-hop BAP address field 512 matches the address of the IAB node (IAB-node 607 or 602) associated with the determined ingress BH link to be used for forwarding the flow control feedback). In step 1402, if an egress RLC channel ID in the list is not found in the received flow control feedback, then the intermediate IAB-node 606 updates information included in the flow control feedback by appending or adding the mapped ingress RLC channel ID (e.g. in field 711 or in field 811) and the associated local status or associated local status information (e.g. in field 712 or in fields 812 and 813) in the flow control feedback to provide an updated flow control feedback to forward.

The steps 1401 and 1402 are repeated for each selected/determined ingress BH link to forward the flow control feedback. Thus, in case of forwarding to several IAB-nodes, the content of the forwarded flow control feedback may be different for each targeted IAB-node.

FIG. 15 illustrates, using a flowchart 1500, an exemplary method for updating the flow control feedback by removing a BAP routing ID and associated status (also referred to as associated status information) in the flow control feedback to provide an updated flow control feedback to be forwarded by an IAB-node acting as an intermediate IAB-node according to embodiments of the invention. The intermediate IAB-node may be implemented in a communication device 1900 as shown in FIG. 19 below with the method as shown in FIG. 15 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises link identification information, including at least one routing identifier (e.g. at least one BAP routing identifier (ID) as described above with reference to FIG. 3), and status information (which may be available buffer size and/or radio quality) for (or associated with) the routing identifier and may have the format as shown in FIGS. 7b and 8b.

Briefly, in step 1501, the intermediate IAB-node 606 gets or identifies a BAP Routing ID from the received flow control feedback and a selected BH link (i.e. one of the determined at least one ingress BH link which is determined as described above) to forward the flow control feedback. In step 1502, if the BAP Routing ID is not in a list of BAP Routing IDs associated to the selected/determined ingress BH link to forward the flow control feedback, then the intermediate IAB-node 606 updates information included in the flow control feedback by removing the BAP routing ID (e.g. field 761 or field 861) and the associated status or associated status information (e.g. field 762 or fields 862 and 863) in the flow control feedback to provide an updated flow control feedback to forward. The step 1502 relies on the existence of a mapping information/table providing the correspondence between BAP routing ID and ingress backhaul link (i.e. per prior-hop BAP address), which is provided to the IAB-node 606 as mentioned above in the description of FIG. 11. A determination that no entry is found resulting in removal of the BAP routing ID and associated status occurs when the identified BAP routing identifier in the flow control feedback does not match the BAP routing identifier in the BAP routing identifier field of an entry and the determined ingress backhaul link is associated with an IAB node having an address that does not match a prior hop address in the prior hop address field of the entry.

The steps 1501 and 1502 are repeated for each BAP routing ID reported in the received flow control feedback and for each selected/determined ingress BH link to forward the flow control feedback. Thus, in case of forwarding to several IAB-nodes, the content of the forwarded flow control feedback may be different for each targeted IAB-node. For example, as discussed above with respect to FIG. 13.

FIG. 16 illustrates, using a flowchart 1600, an exemplary method for updating the flow control feedback by appending or adding a BAP routing ID and associated status (also referred to as associated status information) in the flow control feedback to provide an updated flow control feedback to be forwarded by an IAB-node acting as an intermediate IAB-node according to embodiments of the invention. The intermediate IAB-node may be implemented in a communication device 1900 as shown in FIG. 19 below with the method as shown in FIG. 16 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). The received flow control feedback comprises link identification information, including at least one routing identifier (e.g. at least one BAP routing identifier (ID) as described above with reference to FIG. 3), and status information (which may be available buffer size and/or radio quality) for (or associated with) the routing identifier and may have the format as shown in FIGS. 7b and 8b.

Briefly, in step 1601, the intermediate IAB-node 606 gets or identifies a BAP Routing ID in the list of BAP Routing ID associated to a selected link (i.e. one of the determined at least one ingress BH link which is determined as described above) to forward the flow control feedback. The step 1601 relies on the existence of a mapping information/table providing the correspondence between BAP routing ID and ingress backhaul link (i.e. per prior-hop BAP address), provided to the IAB-node 606 as mentioned above in the description of FIG. 11. In step 1602, if the BAP Routing ID in the list of BAP Routing ID associated to a determined ingress BH link is not found in the received flow control feedback, then the intermediate IAB-node 606 updates information included in the flow control feedback by appending or adding the BAP Routing ID and the associated status in the flow control feedback to provide an updated flow control feedback to forward.

The steps 1601 and 1602 are repeated for each selected/determined ingress BH link to forward the flow control feedback. Thus, in case of forwarding to several IAB-nodes, the content of the forwarded flow control feedback may be different for each targeted IAB-node.

FIG. 17 illustrates, using a flowchart 1700, an exemplary method for updating the flow control feedback by updating the available buffer size status for a reported BH RLC channel ID (e.g. field 712 or 812) or a reported BAP routing ID (e.g. field 762 or 862) in the flow control feedback to provide an updated flow control feedback to be forwarded by an IAB-node acting as an intermediate IAB-node according to embodiments of the invention. The IAB-node may update the available buffer size information related to a BH RLC channel ID or a BAP routing ID according to its own buffer status. The intermediate IAB-node may be implemented in a communication device 1900 as shown in FIG. 19 below with the method as shown in FIG. 17 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). In one example, the received flow control feedback comprises link identification information, including at least one backhaul RLC channel ID, and status information (which may be available buffer size and/or radio quality) for (or associated with) the backhaul RLC channel ID and may have the format as shown in FIGS. 7a and 8a. In another example, the received flow control feedback comprises link identification information, including at least one routing identifier (e.g. at least one BAP routing identifier (ID) as described above with reference to FIG. 3), and status information (which may be available buffer size and/or radio quality) for (or associated with) the routing identifier and may have the format as shown in FIGS. 7b and 8b.

Briefly, in step 1701, the intermediate IAB-node 606 gets or identifies the available buffer size in the received flow control feedback for a BH RLC channel ID (or respectively a BAP Routing ID). For example, the available buffer size is indicated in status information (in field 712 or 812 for BH RLC channel ID or field 762 or 862 for BAP routing ID) of the received flow control feedback. In step 1702, the intermediate IAB-node 606 gets or determines the local available buffer size for at least one internal buffer at the IAB-node 606. The at least one internal buffer is associated with the backhaul RLC channel identified by the BH RLC channel ID (or is associated with a BAP Routing ID) in the flow control feedback. A comparison is then made to compare the local available buffer size of the buffer at the IAB node with the available buffer size included in the status information of the flow control feedback. In step 1703, if the local available buffer size is smaller than or less than the received available buffer size, then the intermediate IAB-node 606 updates information included in the flow control feedback by updating the available buffer size in the received flow control feedback with the local available buffer size to provide an updated flow control feedback to forward. In an example, an update indicator may be added to indicate that the value in the available buffer size field is an updated value (i.e. to indicate that the available buffer size has been replaced with the local available buffer size). The update indicator may comprise one bit of the field 712 (or 762, or 812, or 862) which may be set to a predetermined value to indicate that the available buffer size has been replaced with the local available buffer size.

Alternatively, in step 1703, the intermediate IAB-node 606 may update information included in the flow control feedback by adding or appending the local available buffer size to the received available buffer size. It means that the flow control feedback will contain several status for the same BH RLC channel ID (respectively BAP routing ID) with a duplication of fields 711 (or 761, 811, 861) and 712 (or 762, 812, 862). The order may be predefined with the local status first and then followed by one or several remote status.

The steps 1701 and 1702 are repeated for each BH RLC channel ID (or respectively BAP routing IDs) reported in the received flow control feedback.

FIG. 18 illustrates, using a flowchart 1800, an exemplary method for updating the flow control feedback by updating the radio quality for a reported BH RLC channel ID (e.g. filed 813) or a reported BAP routing ID (e.g. filed 863) in the flow control feedback to provide an updated flow control feedback to be forwarded by an IAB-node acting as intermediate IAB-node according to embodiments of the invention. The intermediate IAB-node may be implemented in a communication device 1900 as shown in FIG. 19 below with the method as shown in FIG. 18 being performed by the central processing unit 1911. The intermediate IAB-node may be one of the IAB-nodes 602, 603, 604, 606, 607. In the following, it is assumed that the IAB-node is IAB-node 606 and flow control feedback is received at the IAB-node 606 over an egress backhaul link or BH link between the IAB-node 606 and another IAB-node (such as from IAB-node 607 over egress BH link 667 for downstream communications or from IAB-node 602 over egress BH link 626 for upstream communications). In one example, the received flow control feedback comprises link identification information, including at least one backhaul RLC channel ID, and status information (which may be available buffer size and/or radio quality) for (or associated with) the backhaul RLC channel ID and may have the format as shown in FIGS. 7a and 8a. In another example, the received flow control feedback comprises link identification information, including at least one routing identifier (e.g. at least one BAP routing identifier (ID) as described above with reference to FIG. 3), and status information (which may be available buffer size and/or radio quality) for (or associated with) the routing identifier and may have the format as shown in FIGS. 7b and 8b.

Briefly, in step 1801, the intermediate IAB-node 606 gets or identifies the BH radio quality in the received flow control feedback for a BH RLC channel ID (or respectively a BAP Routing ID). For example, the radio quality is indicated in status information (in field 813 or 816 for BH RLC channel ID or field 863 or 866 for BAP routing ID) of the received flow control feedback for a particular BH RLC channel ID (or respectively, a particular BAP Routing ID). In step 1802, the intermediate IAB-node 606 gets or determines the local BH radio quality for a selected/determined ingress BH link to forward the flow control feedback. The determined ingress BH link is determined based on the particular BH RLC channel ID in the flow control feedback (or respectively, a particular BAP Routing ID). This local BH radio quality may be indicated by a lower layer (RLC, MAC, or PHY) and may be an index representative of the SINR (Signal-to-Interference-Plus-Noise Ratio), or any other quality metric such as the available throughput, data packet loss or the average number of retransmissions per data packets etc. as discussed above with reference to FIGS. 8a and 8b. A comparison is then made to compare the local radio quality for the determined ingress backhaul link with the radio quality included in the status information of the flow control feedback. In step 1803, if the local BH radio quality for the selected ingress BH link is worse than (less than) the received radio quality, then the intermediate IAB-node 606 updates information included in the flow control feedback by updating the BH radio quality in the received flow control feedback with the local BH radio quality for the selected/determined ingress BH link to provide an updated flow control feedback to forward. In an example, an update indicator may be added to indicate that the value in the radio quality field is an updated value (i.e. to indicate that the radio quality has been replaced with the local radio quality). The update indicator may comprise one bit of the field 813 (or 863 or 863 or 866) which may be set to a predetermined value to indicate that the radio quality has been replaced with the local radio quality.

For a flow control feedback per BH RLC channel ID, the reported BH radio quality may take into account the BH radio quality of several egress BH links. Indeed, BAP PDUs with different BAP routing ID may be transmitted over the same BH RLC channel on a BH link, for instance on BH link 667 between the IAB-nodes 606 and 607 in the FIG. 6. Then, in IAB-node 607 some of these BAP PDUs will be routed toward IAB-node 608 on the BH link 678 and the other BAP PDUs (with a different BAP routing ID) will be routed toward IAB-node 605 on the BH link 657. As a result, the BH radio quality associated to the BH RLC channel in the BH link 667 may be reported to IAB-node 606 in a flow control feedback per BH RLC channel ID with a value taking into account the BH radio quality for the BH links 657 and 678.

Alternatively in step 1803, the intermediate IAB-node 606 may update information included in the flow control feedback by adding or appending the local BH radio quality to the received radio quality. It means that the flow control feedback will contain several status for the same BH RLC channel ID (or respectively BAP routing ID) with a duplication of fields 811 (or 861), 812 (or 862) and 813 (or 863). The order may be predefined with the local status first and then followed by one or several remote status.

The steps 1801 and 1802 are repeated for each BH RLC channel ID (or respectively BAP routing IDs) reported in the received flow control feedback, and for each selected/determined ingress BH link to forward the flow control feedback.

All the flowcharts described in the FIG. 9 to FIG. 18 are applicable for flow control in downstream and upstream directions.

FIG. 19 shows a schematic representation of an example communication device or station, in accordance with one or more embodiments and examples of the present disclosure.

The communication device 1800 may preferably be a device such as a micro-computer, a workstation or a light portable device. The communication device 1900 comprises a communication bus 1913 to which there are preferably connected:
a central processing unit 1911, such as a microprocessor, denoted CPU;
memory for storing data and computer programs containing instructions for the operation of the communication device 1900. The computer programs may contain a number of different program elements or sub-routines containing instructions for a variety of operations and for implementing the invention. For example, the program elements include an element to implement a BAP entity which as discussed above is for routing of data packets between different network nodes in the IAB network; and
at least one communication interface 1902 connected to the radio communication network 100 over which digital data packets or frames or control frames are transmitted, for example a wireless communication network according to the release 16 for 5G NR. The frames are written from a FIFO sending memory in RAM 1912 to the network interface for transmission or are read from the network interface for reception and writing into a FIFO receiving memory in RAM 1912 under the control of a software application running in the CPU 1911.

Each of a donor CU, an IAB network node or IAB node and a donor DU may comprise such a communication device 1900.

The central processing unit 1911 may be a single processor or may comprise two or more processors carrying out the processing required for the operation of the communication device 1900. The number of processors and the allocation of processing functions to the central processing unit 1911 is a matter of design choice for a skilled person.

The memory may include:
a read only memory 1907, denoted ROM, for storing computer programs for implementing the invention;
a random-access memory 1912, denoted RAM, for storing the executable code of methods according to one or more embodiments of the invention as well as the registers adapted to record variables and parameters necessary for implementing methods according to one or more embodiments of the invention.

Optionally, the communication device 1900 may also include the following components:
a data storage means 1904 such as a hard disk, for storing computer programs—for implementing methods according to one or more embodiments of the invention;
a disk drive 1905 for a disk 1906, the disk drive being adapted to read data from the disk 1906 or to write data onto said disk;
a screen 1909 for displaying decoded data and/or serving as a graphical interface with the user, by means of a keyboard 1190 or any other pointing means.

Preferably the communication bus provides communication and interoperability between the various elements included in the communication device 1900 or connected to it. The representation of the bus is not limiting and in particular, the central processing unit is operable to communicate instructions to any element of the communication device 1900 directly or by means of another element of the communication device 1900.

The disk 1906 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1907, on the hard disk 1904 or on a removable digital medium such as for example a disk 1906 as described previously. According to an optional variant, the executable code of the programs can be received by means of the communication network 1903, via the interface 1902, in order to be stored in one of the storage means of the communication device 1900, such as the hard disk 1904, before being executed.

The central processing unit 1911 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1904 or in the read only memory 1907, are transferred into the random-access memory 1912, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC).

A long-term congestion on a backhaul link may not be alleviated using the flow control mechanism triggered at BAP sublayer without having to rely on dropping packets. Indeed, the data rate reduction in the scheduler of a parent IAB-node receiving a flow control feedback from a child IAB-node may alleviate a downstream congestion in the child IAB-node, but it may lead to a congestion in the parent IAB-node that will need to send in turn a flow control feedback. The flow control mechanism may be repeated up to the IAB-Donor-DU, which may also experience a congestion leading to dropping packets.

Actually, there are two possible options to help mitigate the congestion. As a first option, an IAB-node or an IAB-donor-DU may reroute some BAP PDUs on an alternative path when it is already configured by the Donor-CU. As a second option, the IAB-Donor-CU can be warned by an IAB-node in order to compute a new routing configuration for all or part of the network, and to reconfigure the IAB-nodes accordingly. The drawback of both solutions is that it may take a long time to apply the corrective action, and packet dropping may not be avoided. For example, it may take a long time to apply the hop-by-hop flow control mechanism of release-16, and to reach an IAB-node able to reroute BAP PDUs. Furthermore, the time to warn the IAB-Donor-CU and to apply a new configuration may take even a longer time.

Thus, by enabling an IAB-node to forward the flow control feedback received from a child IAB-node, the time to reach an IAB-node that may be able to reroute some BAP PDUs on an alternative path can be significantly reduced.

It is therefore proposed that an IAB-node may forward a flow control feedback received from a child IAB-node toward its parent IAB-node(s).

The decision to forward a flow control feedback may be based on a configuration provided by the IAB-donor CU. As a first example, an IAB-node may systematically forward a received flow control feedback. As another example, an IAB-node may estimate if the flow control feedback indicates a situation of congestion with the need to attempt a corrective action, for instance, if the available buffer size for a BH RLC channel (or BAP routing ID) is below a predetermined threshold. For such flow control feedback, the IAB-node may decide to forward it immediately or it may evaluate the feasibility of a local corrective action like a data rate adaptation in the scheduler or packets rerouting on an alternative path. When no corrective action can be efficiently applied, the IAB-node then decides to forward the flow control feedback.

It is then proposed that the decision by an IAB-node to forward a flow control feedback may be based on a configuration provided by the IAB-donor-CU.

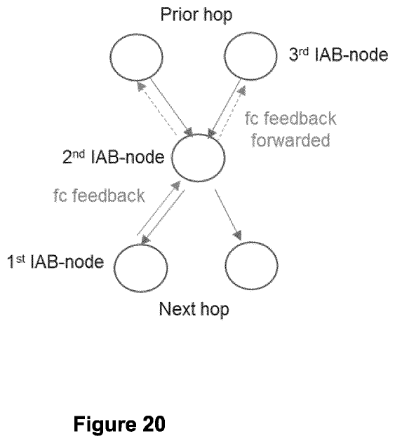

A flow control feedback reports an available buffer size per BH RLC channel ID or per BAP routing ID. Since the BH RLC channel ID only has link-local scope, some flow control feedback with a reporting per RLC channel ID, issued by a first IAB-node and forwarded by a second IAB-node to a third IAB-node may not be understood by this third IAB-node. See the example arrangement in FIG. 20. Thus, before forwarding a flow control feedback, it is proposed to adapt its content by updating the BH RLC channel ID (i.e. the one for the BH link between the second and first IAB-nodes) with the BH RLC channel ID associated to the BH link between the second and third IAB-nodes.

The determination of the associated BH RLC channel ID for updating is based on the BH RLC channel mapping configuration. Thus, the ingress RLC channel ID of the entry to be considered in the BH RLC channel mapping configuration is the one for which:
the egress RLC channel ID field matches the BH RLC channel ID in the received flow control feedback,
the next-hop BAP address field matches the egress BH link on which the flow control feedback is received,
the prior-hop BAP address field matches the selected ingress BH link to forward the flow control feedback.

It is therefore proposed that when forwarding a flow control feedback per BH RLC channel ID, an IAB-node should remap the BH RLC channel ID according to its BH RLC channel mapping configuration.

Besides, the flow control feedback from a first IAB-node includes information on the available buffer size that provides a status of the buffer load in the first IAB-node only, and it does not take into account the buffer load status in the second IAB-node. Thus, before forwarding a flow control feedback, it is proposed to update the flow control feedback so as to replace the available buffer size in the first IAB-node with the available buffer size in the second IAB-node when the buffer load in the second IAB-node is greater than the buffer load in the first IAB-node. Alternatively, the available buffer size in the second IAB-node is added to the flow control feedback in addition to the available buffer size in the first IAB-node, so that the buffer load status in the different IAB-nodes can then be taken into account by the third IAB-node.

It is then proposed that when forwarding a flow control feedback, an IAB-node may update the available buffer size information related to a BH RLC channel ID or a BAP routing ID according to its own buffer status.

Furthermore, an IAB-node may append one or several BH RLC channel IDs or one or several BAP routing IDs status in the flow control feedback to forward, when the targeted IAB-node is concerned by these BH RLC channel IDs or BAP routing IDs not reported in the received flow control feedback. Also, an IAB-node may remove one or several BH RLC channel IDs status or one or several BAP routing IDs status in the flow control feedback to forward, when the targeted IAB-node is not concerned by these BH RLC channel IDs or BAP routing IDs.

It is also proposed that when forwarding a flow control feedback, an IAB-node may append or remove some BH RLC channel IDs or BAP routing ID status.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

1. A method for processing a flow control feedback in an Integrated Access and Backhaul, IAB, network comprising a plurality of IAB nodes, each IAB node of the plurality of IAB nodes configured to deliver data received over an ingress link to an egress link for transmission, the method, at the IAB node, comprising:
receiving, from another IAB node over an egress backhaul link between the IAB node and the another IAB node, a flow control feedback comprising link identification information;
determining at least one ingress backhaul link for use in forwarding the flow control feedback;
updating information included in the flow control feedback for at least one of the determined at least one ingress backhaul link to provide an updated flow control feedback for the at least one of the determined at least one ingress backhaul link, wherein updating information included in the flow control feedback includes updating the link identification information included in the flow control feedback;
transmitting the updated flow control feedback over the at least one of the determined at least one ingress backhaul link.

2. The method of claim 1, wherein determining at least one ingress backhaul link comprises determining, based on the link identification information, at least one ingress backhaul link for use in forwarding the flow control feedback.

3. The method of claim 1 wherein the link identification information includes a backhaul RLC channel identifier for identifying a backhaul RLC channel of the egress backhaul link.

4. The method of claim 3, wherein the IAB node is configured with backhaul RLC channel mapping configuration information for mapping backhaul RLC channel identifiers from egress to ingress backhaul links,
wherein determining at least one ingress backhaul link comprises determining, based on the backhaul RLC channel identifier for the egress backhaul link and the backhaul RLC channel mapping configuration information, the at least one ingress backhaul link.

5. The method of claim 4, further comprising:
for at least one of the determined at least one ingress backhaul link, determining a backhaul RLC channel identifier for a backhaul RLC channel of the ingress backhaul link associated with the backhaul RLC channel identifier for the egress backhaul link using the backhaul RLC channel mapping configuration information,
wherein updating information included in the flow control feedback for the at least one of the determined at least one ingress backhaul link comprises:
updating the link identification information of the flow control feedback to replace the backhaul RLC channel identifier for identifying a backhaul RLC channel of the egress backhaul link in the flow control feedback with the backhaul RLC channel identifier for the backhaul RLC channel of the ingress backhaul link to provide the updated flow control feedback for transmission over the ingress backhaul link.

6. The method of claim 4, further comprising:
for at least one of the determined at least one ingress backhaul link, determining, at least one additional backhaul RLC channel of the ingress backhaul link not associated with the backhaul RLC channel of the egress backhaul link using the backhaul RLC channel mapping configuration information;
for each of the at least one additional backhaul RLC channel, determining the backhaul RLC channel identifier of the additional backhaul RLC channel and status information for the additional backhaul RLC channel,
wherein updating information included in the flow control feedback for the at least one of the determined at least one ingress backhaul link comprises:
updating the flow control feedback to include the backhaul RLC channel identifier and status information for the at least one additional backhaul RLC channel.

7. The method of claim 3, wherein the link identification information includes a first backhaul RLC channel identifier for a first backhaul RLC channel of the egress backhaul link and a second backhaul RLC channel identifier for a second backhaul RLC channel of the egress backhaul link and wherein the flow control feedback further comprises first status information for the first backhaul RLC channel and second status information for the second backhaul RLC channel,
wherein determining at least one ingress backhaul link comprises determining, based on the first backhaul RLC channel identifier, a first ingress backhaul link and determining, based on the second backhaul RLC channel identifier, a second ingress backhaul link,
wherein updating information included in the flow control feedback for at least one of the determined at least one ingress backhaul link comprises:
updating information included in the flow control feedback for the first ingress backhaul link by removing the second backhaul RLC channel identifier and second status information for the second backhaul RLC channel to provide a first updated flow control feedback for the first ingress backhaul link,
wherein transmitting the updated flow control feedback comprises transmitting the first updated flow control feedback over the first ingress backhaul link.

8. The method of claim 7, wherein updating information included in the flow control feedback for at least one of the determined at least one ingress backhaul link further comprises:
updating information included in the flow control feedback for the second ingress backhaul link by removing the first backhaul RLC channel identifier and first status information for the first backhaul RLC channel to provide a second updated flow control feedback for the second ingress backhaul link;
wherein transmitting the updated flow control feedback comprises transmitting the second updated flow control feedback over the second ingress backhaul link.

9. The method of claim 3, wherein the IAB node is configured with a backhaul RLC channel mapping configuration table including at least one entry, each entry having a next hop address field for a next hop address of a IAB node that is next to the IAB node in a routing path for data, a prior hop address field for a prior hop address of a prior hop IAB node that is prior to the IAB node in the routing path for data, an ingress backhaul RLC channel identifier field for the backhaul RLC channel identifier of a backhaul RLC channel of an ingress backhaul link between the IAB node and the prior hop IAB node and an egress backhaul RLC channel identifier field for a backhaul RLC channel identifier of a backhaul RLC channel for an egress backhaul link between the IAB node and the next hop IAB node,
wherein determining at least one ingress backhaul link comprises:
identifying a backhaul RLC channel identifier in the flow control feedback;
checking each entry in the backhaul RLC channel mapping configuration table to determine whether the identified backhaul RLC channel identifier in the flow control feedback matches a egress backhaul RLC channel identifier in the egress backhaul RLC channel identifier field of an entry and whether an address of the another IAB node matches a next hop address in the next hop address field of the entry;
when the identified backhaul RLC channel identifier in the flow control feedback matches the egress backhaul RLC channel identifier in the egress backhaul RLC channel identifier field of an entry and the address of the another IAB node matches the next hop address in the next hop address field of the entry, identifying a matched entry;
for each matched entry, using the prior hop address in the prior hop address field of the matched entry to identify an IAB node as a prior hop IAB node having the prior hop address and determining a backhaul link between the prior hop IAB node and the IAB node as an ingress backhaul link for use in forwarding the flow control feedback.

10. The method of claim 9, further comprising:
checking each entry in the backhaul RLC channel mapping configuration table to determine whether the identified backhaul RLC channel identifier in the flow control feedback matches an egress backhaul RLC channel identifier in the egress backhaul RLC channel identifier field of an entry, whether an address of the another IAB node matches a next hop address in the next hop address field of the entry and whether the determined ingress backhaul link is associated with an IAB node having an address that matches a prior hop address in the prior hop address field of the entry;
when the identified backhaul RLC channel identifier in the flow control feedback matches the egress backhaul RLC channel identifier in the egress backhaul RLC channel identifier field of an entry, the address of the another IAB node matches the next hop address in the next hop address field of the entry, and the determined ingress backhaul link is associated with an IAB node having an address that matches a prior hop address in the prior hop address field of the entry, identifying a matched entry;
for the matched entry, identifying the backhaul RLC channel identifier in the ingress backhaul RLC channel identifier field of the matched entry as the backhaul RLC channel identifier for the determined ingress backhaul link,
wherein updating information included in the flow control feedback comprises:
updating the link identification information of the flow control feedback to include the identified backhaul RLC channel identifier for the determined ingress backhaul link to provide the updated flow control feedback for transmission over the determined ingress backhaul link.

11. The method of claim 10, wherein updating the link identification information comprises replacing the backhaul RLC channel identifier for the egress backhaul link with the identified backhaul RLC channel identifier for the ingress backhaul link.

12. The method of claim 9, wherein the flow control feedback further comprises status information for the backhaul RLC channel identified by the identified backhaul RLC channel identifier, the method further comprising:
checking each entry in the backhaul RLC channel mapping configuration table to determine whether the identified backhaul RLC channel identifier in the flow control feedback matches an egress backhaul RLC channel identifier in the egress backhaul RLC channel identifier field of an entry, and whether the determined ingress backhaul link is associated with an IAB node having an address that matches a prior hop address in the prior hop address field of the entry;
when the identified backhaul RLC channel identifier in the flow control feedback does not match the egress backhaul RLC channel identifier in the egress backhaul RLC channel identifier field of an entry, or the determined ingress backhaul link is associated with an IAB node having an address that does not match a prior hop address in the prior hop address field of the entry, determining no matched entry is found;
wherein updating information included in the flow control feedback comprises:
removing, from the flow control feedback, the identified backhaul RLC channel ID and the status information for the backhaul RLC channel to provide the updated flow control feedback for transmission over the determined ingress backhaul link.

13. The method of claim 3, wherein the flow control feedback further comprises status information including available buffer size for the backhaul RLC channel identified by the backhaul RLC channel identifier in the link identification information of the flow control feedback, the method further comprising:
determining the local available buffer size of at least one buffer at the IAB node, the at least one buffer being associated with the backhaul RLC channel identified by the backhaul RLC channel identifier in the flow control feedback;
comparing the local available buffer size of the buffer at the IAB node with the available buffer size included in the status information of the flow control feedback;
when the local available buffer size is less than the available buffer size included in the status information of the flow control feedback, updating information included in the flow control feedback by updating the status information to include the local available buffer size to provide the updated flow control feedback.

14. The method of claim 13, wherein updating the status information includes:
replacing the available buffer size included in the status information of the flow control feedback with the local available buffer size; or
replacing the available buffer size included in the status information of the flow control feedback with the local available buffer size and adding an update indicator to indicate that the available buffer size has been replaced with the local available buffer size; or
appending the local available buffer size to the available buffer size included in the status information of the flow control feedback.

15-16. (canceled)

17. The method of claim 1, wherein the link identification information includes a routing identifier for identifying a routing path for routing data in the IAB network to a destination IAB node.

18. The method of claim 17, further comprising providing mapping information for mapping at least one routing identifier to at least one ingress backhaul link,
wherein determining at least one ingress backhaul link comprises determining, based on the routing identifier and the mapping information, the at least one ingress backhaul link.

19. The method of claim 17, wherein the routing identifier is a Backhaul Adaptation Protocol, BAP, routing identifier including a path identifier for identifying a routing path for routing data in the IAB network to a destination IAB node, and an address of the destination IAB node.

20. The method of claim 17, wherein the link identification information includes a first routing identifier for a first routing path and a second routing identifier for a second routing path and wherein the flow control feedback further comprises first status information associated with the first routing identifier and second status information associated with the second routing identifier,
wherein determining at least one ingress backhaul link comprises determining, based on the first routing identifier, a first ingress backhaul link and determining, based on the second routing identifier, a second ingress backhaul link,
wherein updating information included in the flow control feedback for at least one of the determined at least one ingress backhaul link comprises:
updating information included in the flow control feedback for the first ingress backhaul link by removing the second routing identifier and second status information to provide a first updated flow control feedback for the first ingress backhaul link,
wherein transmitting the updated flow control feedback comprises transmitting the first updated flow control feedback over the first ingress backhaul link.

21. The method of claim 20, wherein updating information included in the flow control feedback for at least one of the determined at least one ingress backhaul link further comprises:
updating information included in the flow control feedback for the second ingress backhaul link by removing the first routing identifier and first status information to provide a second updated flow control feedback for the second ingress backhaul link;
wherein transmitting the updated flow control feedback comprises transmitting the second updated flow control feedback over the second ingress backhaul link.

22. The method of claim 17, further comprising:
for at least one of the determined at least one ingress backhaul link, determining at least one additional routing identifier for an additional routing path associated with the at least one of the determined at least one ingress backhaul link, the at least one additional routing identifier not being included in the link identification information of the received flow control feedback;
for each of the at least one additional routing identifier, determining status information associated with the additional routing path,
wherein updating information included in the flow control feedback for the at least one of the determined at least one ingress backhaul link comprises:
updating the flow control feedback to include the at least one additional routing identifier and status information associated with the at least one additional routing path.

23. The method of claim 18, wherein the routing identifier is a Backhaul Adaptation Protocol, BAP, routing identifier including a path identifier for identifying a routing path for routing data in the IAB network to a destination IAB node, and an address of the destination IAB node, wherein the mapping information comprises a mapping table including at least one entry, each entry having a BAP routing identifier field for a BAP routing identifier and a prior hop address field for an address of a IAB node that is prior to the IAB node in the routing path identified by the BAP routing identifier,
wherein determining at least one ingress backhaul link comprises:
identifying a BAP routing identifier in the flow control feedback;
checking each entry in the mapping table to determine whether the identified BAP routing identifier in the flow control feedback matches the BAP routing identifier in the BAP routing identifier field;
when the identified BAP routing identifier in the flow control feedback matches the BAP routing identifier in the BAP routing identifier field of an entry, identifying a matched entry;
for each matched entry, using the address in the prior hop address field of the entry to identify an IAB node as a prior hop IAB node and determining a backhaul link between the prior hop IAB node and the IAB node as an ingress backhaul link for use in forwarding the flow control feedback.

24. The method of claim 23, wherein the flow control feedback further comprises status information associated with the identified BAP routing identifier in the flow control feedback, the method further comprising:
when the identified BAP routing identifier in the flow control feedback does not match the BAP routing identifier in the BAP routing identifier field of an entry and the determined ingress backhaul link is associated with an IAB node having an address that does not match a prior hop address in the prior hop address field of the entry, determining no matched entry is found;
wherein updating information included in the flow control feedback comprises:
removing, from the flow control feedback, the identified BAP routing identifier and the status information for the routing path identified by the identified BAP routing identifier to provide the updated flow control feedback for transmission over the determined ingress backhaul link.

25. The method of claim 17, wherein the flow control feedback further comprises status information including available buffer size associated with the routing identifier in the link identification information of the flow control feedback, the method further comprising:
determining the local available buffer size of at least one buffer at the IAB node, the at least one buffer being associated with the routing identifier in the link identification information of the flow control feedback;
comparing the local available buffer size of the buffer at the IAB node with the available buffer size included in the status information of the flow control feedback;
when the local available buffer size is less than the available buffer size included in the status information of the flow control feedback, updating information included in the flow control feedback by updating the status information to include the local available buffer size to provide the updated flow control feedback.

26. The method of claim 25, wherein updating the status information includes:
replacing the available buffer size included in the status information of the flow control feedback with the local available buffer size; or
replacing the available buffer size included in the status information of the flow control feedback with the local available buffer size and adding an update indicator to indicate that the available buffer size has been replaced with the local available buffer size; or
appending the local available buffer size to the available buffer size included in the status information of the flow control feedback.

27-28. (canceled)

29. The method of claim 1, further comprising:
determining the received flow control feedback is to be forwarded.

30. The method of claim 29, wherein determining the received flow control feedback is to be forwarded comprises at least one of:
determining that the received flow control feedback indicates congestion; or
determining that the received flow control feedback indicates congestion and in response to determining that no corrective action for the congestion can be performed by the IAB node.

31. (canceled)

32. The method of claim 1, wherein updating the link identification information includes replacing or removing the link identification information in the flow control feedback.

33. The method of claim 3, wherein updating the link identification information included in the flow control feedback includes updating the link identification information of the flow control feedback by replacing the backhaul RLC channel identifier for identifying the backhaul RLC channel of the egress backhaul link in the flow control feedback with a backhaul RLC channel identifier for a backhaul RLC channel of the at least one of the determined at least one ingress backhaul link to provide the updated flow control feedback.

34. A method for processing a flow control feedback in an Integrated Access and Backhaul, IAB, network comprising a plurality of IAB nodes, each IAB node of the plurality of IAB nodes configured to deliver data received over an ingress link to an egress link for transmission, the method, at the IAB node, comprising:
receiving, from another IAB node over an egress backhaul link between the IAB node and the another IAB node, a flow control feedback comprising a Backhaul Adaptation Protocol, BAP, routing identifier including a path identifier for identifying a routing path for routing data in the IAB network to a destination IAB node, and an address of the destination IAB node;
determining, based on the BAP routing identifier, at least one ingress backhaul link for use in forwarding the flow control feedback;
updating information included in the flow control feedback for the at least one of the determined at least one ingress backhaul link to provide an updated flow control feedback, wherein updating information included in the flow control feedback includes updating BAP routing identifier information included in the flow control feedback for the at least one of the determined at least one ingress backhaul link;
transmitting the updated flow control feedback over the at least one ingress backhaul link.

35. An apparatus for an Integrated Access and Backhaul, IAB, node for an IAB network, the apparatus comprising:
at least one processor configured to:
receive, from another IAB node over an egress backhaul link between the IAB node and the another IAB node, a flow control feedback comprising link identification information;
determine at least one ingress backhaul link for use in forwarding the flow control feedback;
update information included in the flow control feedback for at least one of the determined at least one ingress backhaul link to provide an updated flow control feedback for the at least one of the determined at least one ingress backhaul link, wherein updating information included in the flow control feedback includes updating the link identification information included in the flow control feedback;
transmitting the updated flow control feedback over the at least one of the determined at least one ingress backhaul link.

36. (canceled)

37. A non-transitory computer-readable storage medium carrying a computer program comprising instructions which, when the computer program is executed by at least one processor of an Integrated Access and Backhaul, IAB, node, cause the at least one processor to:
receive, from another IAB node over an egress backhaul link between the IAB node and the another IAB node, a flow control feedback comprising link identification information;
determine at least one ingress backhaul link for use in forwarding the flow control feedback;
update information included in the flow control feedback for at least one of the determined at least one ingress backhaul link to provide an updated flow control feedback for the at least one of the determined at least one ingress backhaul link, wherein updating information included in the flow control feedback includes updating the link identification information included in the flow control feedback;
transmitting the updated flow control feedback over the at least one of the determined at least one ingress backhaul link.

38. The method of claim 17, wherein updating the link identification information included in the flow control feedback includes removing one or more routing identifiers not associated with the at least one of the determined at least one ingress backhaul link.

39. The method of claim 34, wherein updating the BAP routing identifier information includes removing one or more BAP routing identifiers not associated with the at least one of the determined at least one ingress backhaul link.

40. The apparatus of claim 35, wherein determining at least one ingress backhaul link comprises determining, based on the link identification information, at least one ingress backhaul link for use in forwarding the flow control feedback.

41. The apparatus of claim 35, wherein the link identification information includes a backhaul RLC channel identifier for identifying a backhaul RLC channel of the egress backhaul link.

42. The apparatus of claim 35, wherein updating the link identification information includes replacing or removing the link identification information in the flow control feedback.

43. The apparatus of claim 41, wherein updating the link identification information included in the flow control feedback includes updating the link identification information of the flow control feedback by replacing the backhaul RLC channel identifier for identifying the backhaul RLC channel of the egress backhaul link in the flow control feedback with a backhaul RLC channel identifier for a backhaul RLC channel of the at least one of the determined at least one ingress backhaul link to provide the updated flow control feedback.

44. The apparatus of claim 35, wherein the link identification information includes a routing identifier for identifying a routing path for routing data in the IAB network to a destination IAB node.

45. The apparatus of claim 44, wherein the routing identifier is a Backhaul Adaptation Protocol, BAP, routing identifier including a path identifier for identifying a routing path for routing data in the IAB network to a destination IAB node, and an address of the destination IAB node.

46. The apparatus of claim 44, wherein updating the link identification information included in the flow control feedback includes removing one or more routing identifiers not associated with the at least one of the determined at least one ingress backhaul link.

47. The apparatus of claim 45, wherein updating the BAP routing identifier information includes removing one or more BAP routing identifiers not associated with the at least one of the determined at least one ingress backhaul link.
